(19) United States
(12) Patent Application Publication
(10) Pub. No.: US 2011/0022284 A1
(43) Pub. Date: Jan. 27, 2011

(54) Acceleration control device

(75) Inventors: Motoaki Umakoshi, Oobu-shi (JP); Hajime Kumabe, Kariya-shi (JP); Masayoshi Takeda, Kariya-shi (JP); Masatoshi Hanzawa, Kariya-shi (JP)

Correspondence Address: POSZ LAW GROUP, PLC, 12040 SOUTH LAKES DRIVE, SUITE 101, RESTON, VA, 20191, US

(73) Assignees: DENSO CORPORATION, Kariya-city (JP); ADVICS CO., LTD., Kariya-city (JP)

(21) Appl. No.: 12/805,246

(22) Filed: Jul. 20, 2010

(30) Foreign Application Priority Data
Jul. 21, 2009 (JP) 2009-170341

(51) Int. Cl. G06F 19/00

(52) U.S. Cl. 701/70

(57) ABSTRACT

In a cruise assist ECU, when a vehicle drive state is changed from a running state to a state immediately before vehicle stop or from a stop state to a state immediately after vehicle start, a feedback torque gain compensation part changes a feedback torque gain to a second set value, and maintain it during the state immediately before vehicle stop or the state immediately after vehicle start. Because the second set value is smaller than a first set value, a response delay is increased in feedback control of the feedback torque control part when the first set value of the feedback torque gain is switched to the second set value. This makes it possible to slowly change the FB control value during the transition state in elapse of time, and prevent a brake or damping torque generated in the vehicle from being excessively changed in FB control.

### CROSS-REFERENCE TO RELATED APPLICATION

This application is related to and claims priority from Japanese Patent Application No. 2009-170341 filed on Jul. 21, 2009, the contents of which are hereby incorporated by reference.

### BACKGROUND OF THE INVENTION

1. Field of the invention

The present invention relates to an acceleration control device capable of controlling the drive speed of a vehicle in order to obtain a target acceleration which is required by the driving state of the vehicle.

2. Description of the Related Art

An adaptive cruise control system (or an adaptive cruise assist system has been known and is mounted to vehicles. Such a type of the adaptive cruise control system is equipped with a forward scene observation device, a target acceleration calculation device, and an acceleration control device. The forward scene observation device detects the presence of a front vehicle which is running or stopped in front of the driver's vehicle. The target acceleration calculation device calculates a target acceleration value for the driver's vehicle in order to maintain the vehicle distance between a front running vehicle and the driver's vehicle, which is detected by the forward scene observation device, at a predetermined vehicle distance. The acceleration control device controls on-vehicle devices (such as a power train system and a brake system) so that the driver's vehicle runs at the calculated target acceleration.

The acceleration control device performs a feedback control of a drive torque (or a damping torque) so that a difference (or deviation) between an actual acceleration in the longitudinal direction of the driver's vehicle and a target acceleration is zero. For example, Japanese patent laid open publication No. JP 2006-506270 has disclosed such a conventional technique.

The acceleration in the longitudinal direction of the driver's vehicle used in the acceleration control device disclosed in Japanese patent laid open publication No. JP 2006-506270 is a wheel acceleration which is obtained by differentiating a wheel speed detected by a wheel speed sensor mounted to the driver's vehicle, and then passing it through a primary filter. This primary filter can smooth an input signal by multiplying the input signal by a predetermined value (that is, the primary filter is a means to smooth the input signal.

However, the wheel speed sensor generally outputs a detection signal which is varied in pulse form depending on the rotation of the vehicle wheels. The wheel speed of the vehicle is calculated based on the number of pulses detected in the detection signal every predetermined interval of time.

When an actual wheel speed (hereinafter, referred to as the “actual vehicle speed”) of a vehicle which is currently running obtained by such a general wheel speed sensor becomes a low speed (for example, 0.5 km/h, hereinafter, which will be referred to as the “minimum detection speed”) which is less than a resolution of its wheel speed sensor, it becomes difficult to calculate the actual wheel speed of the vehicle when the number of pulses in the detection signal every predetermined interval of time is less than 1. Therefore the wheel speed (actual detection speed) as the detection result of the wheel speed sensor is set to 0 km/h when the number of pulses in the detection signal every predetermined interval of time is less than the above minimum detection speed.

FIG. 14 is a view which explanatory shows a conventional problem caused in a conventional adaptive cruise control device. In particular, FIG. 14 shows the change in wheel speed and acceleration calculated based on an output signal transferred from a wheel speed sensor during a period counted from the state where a vehicle equipped with the conventional adaptive cruise control device is decelerated and stopped to the state where the vehicle restarts and is accelerated.

As shown in FIG. 14, when the driver's vehicle is decelerated and stopped (see “deceleration of driver's vehicle”), an actual detection value of the wheel speed is calculated so that it is sequentially decreased until the actual wheel speed reaches the minimum detection value, but when the detected wheel speed instantly becomes 0 km/h when it has actually become less than the minimum detection speed. Thus, the vehicle wheel speed has a discontinuous change.

Similarly, when the driver's vehicle is accelerated after vehicle stop (see “acceleration of driver's vehicle”), the actual detection value of the wheel speed takes the value of 0 km/h until the actual wheel speed of the driver's vehicle reaches the minimum detection value. When the actual wheel speed of the driver's vehicle reaches the minimum detection value, the actual wheel speed of the driver's vehicle is instantly changed to the minimum detection value from 0 km/h. Thus, there is no continuous change of the actual wheel speed of the driver's vehicle.

As described above, when the actual wheel speed of the driver's vehicle is changed between 0 km/h and the minimum detection value, that is, not continuously changed, because the gradient in change of the actual wheel speed before and after the change becomes infinity, the wheel acceleration of the driver's vehicle before passing through the primary filter also becomes infinity. Although the calculated wheel acceleration is smoothed by the primary filter, the calculated wheel acceleration is different from the actual wheel acceleration given to the driver's vehicle.

When receiving the calculated wheel acceleration, which is different from the actual wheel acceleration, as the acceleration in the longitudinal direction of the driver's vehicle, the acceleration control device greatly changes a control value to determine a damping torque or a drive torque more than required or less than required so that the difference between the target acceleration and the acceleration in the longitudinal direction of the driver's vehicle becomes zero. At this time, on-vehicle devices (such as a power train system and a brake system) therefore generate a large damping torque or a drive torque more than (or less than) required.

This would cause various problems, for example:
(a-1) causing a sudden stop in the driver's vehicle because of generating a large damping torque to the driver's vehicle immediately before vehicle stop;
(a-2) extending a stop distance of the driver's vehicle by lack of a necessary deceleration because of generating a small damping torque in the driver's vehicle;
(a-3) causing a sudden start the driver's vehicle by supplying a large drive torque immediately after the driver's vehicle starts; and
(a-4) giving uncomfortable driving to the passengers and driver of the vehicle because a small drive torque is generated in the driver's vehicle. This causes lack of a necessary acceleration.

That is, the acceleration control device disclosed in Japanese patent laid open publication No. JP 2006-506270 deteriorates comfortable driving for the passengers and driver of the vehicle when the calculated wheel acceleration is different from the actual detection acceleration of the driver's vehicle (in a transient state).

### SUMMARY OF THE INVENTION

It is an object of the present invention to provide an acceleration control device capable of suppressing an error between a detected wheel speed transferred from a wheel speed sensor and an actual wheel speed of a vehicle, where such an error is generated according to the driving state of the vehicle. The acceleration control device is capable of providing comfortable driving to the passengers and driver of the vehicle.

To achieve the above purposes, in accordance with a first aspect of the present invention, there is provided an acceleration control device comprised of a target acceleration calculation means, a wheel speed obtaining means, a wheel acceleration obtaining means, a feedback control means, a drive state detection means, and a control value compensation means.

The target acceleration calculation means calculates a target acceleration in order to control a driving state of a driver's vehicle to a target drive state. The wheel speed obtaining means obtains a wheel speed of the driver's vehicle. The wheel acceleration obtaining means obtains a wheel acceleration of the driver's vehicle.

The feedback control means performs a feedback control of a brake torque or a damping torque generated in the driver's vehicle so that the wheel acceleration obtained by the wheel acceleration obtaining means is equal to the target acceleration calculated by the target acceleration calculation means.

The wheel speed of the driver's vehicle is calculated based on a detection signal detected by and transferred from a wheel speed sensor. The detection signal is changed in pulse form depending on the rotation of wheel of the driver's vehicle. The wheel acceleration is an acceleration which is calculated based on a change value of the wheel speed during a predetermined interval of time.

In the acceleration control device according to the present invention, the drive state detection means detects the driving state of the driver's vehicle including the information regarding the time when the vehicle enters the transition state.

The control value compensation means performs the compensation control to compensate the control value in feedback control in order to increase a response delay of the feedback control when the driving state of the driver's vehicle is shifted to the transition state based on the detection result of the drive state detection means. The actual acceleration in the longitudinal direction of the driver's vehicle is the acceleration which is actually given to the driver's vehicle in the longitudinal direction thereof. The transition state of the driver's vehicle is the drive state where the wheel acceleration and the actual acceleration of the driver's vehicle are different in the longitudinal direction by not less than a predetermined value.

That is, in the acceleration control device according to the first aspect of the present invention, the feedback control makes it possible to provide a small control value (hereinafter, also referred to as the “change control value”) of the drive torque or a damping torque even if the actual acceleration in the longitudinal direction of the driver's vehicle is different from the wheel acceleration after the driving state of the driver's vehicle is shifted to the transition state. That is, the acceleration control device according to the first aspect of the present invention performs the compensation control capable of slowly changing the control value of the drive torque or the damping torque in the elapse of time in order to approach the target acceleration.

According to the acceleration control device of first aspect of the present invention, it is possible to prevent the drive torque and the damping torque generated in the driver's vehicle from being significantly varied. As a result, it is possible for the acceleration control device according to the first aspect of the present invention to avoid a sudden stop or start of the driver's vehicle during the transition state of the driver's vehicle, and to prevent a stop distance of the driver's vehicle from being extended and prevent the acceleration from being decreased less than required, and to improve comfortable driving for the passengers and driver of the vehicle.

In general, a vehicle acceleration is calculated by differentiating the wheel speed detected by the wheel speed sensor mounted to the driver's vehicle, and the calculation result is then passed through the primary filter. In the wheel acceleration obtained through the primary filter, the effect of generating an infinite wheel acceleration appears with a delay when the actually-detected wheel speed is changed between the minimum detection value and the value of 0 km/h (such as vibration to the actual acceleration shown in FIG. 4). That is, it is necessary to require some time length until the wheel acceleration becomes equal to the actual acceleration after the driving state of the driver's vehicle is shifted to the transition state.

In order to solve this, it is possible for the control value compensation means in the acceleration control device to perform the compensation control during the period of the transition state of the driver's vehicle, where the period of the transition state is a time length of the transition state.

This makes it possible to prevent the change value of the drive torque or the damping torque from being larger than required or being smaller than required even if using the wheel acceleration passed through the primary filter after performing the differentiation of the wheel speed.

It is possible to use the period of the transition state which is counted from a timing when the driving state of the driver's vehicle enters the transition state to a timing when a predetermined set time period is elapsed.

It is preferred to set to the predetermined set time period, the value counted from the time when the driver's vehicle enters the transition state to a time when vibration of the wheel acceleration converges into a predetermined range and the passengers and driver of a vehicle do not feel the vibration caused by the wheel acceleration.

It is preferred for the control value compensation means to perform the compensation control to decrease the control gain used in the feedback control, when compared with the control gain before the transition state, in order to increase a response delay of the feedback control.

It is also possible to use the control gain of zero in order to decrease the control gain. The acceleration control device performing the above compensation control of the control gain stops the feed back control (FB control) when the value of zero is set to the control gain after the driving state of the driver's vehicle is shifted to the transition state. This makes it possible to determine the control value of the drive torque (or the damping torque) according to using only the target acceleration.

Even if it is different from the actual acceleration in the longitudinal direction of the driver's vehicle, the wheel acceleration does not affect the change value of the drive torque or the damping torque. As a result, it is possible to prevent the comfortable drive of the passengers and driver of the vehicle from deteriorating by the separation of the wheel acceleration from the actual acceleration in the longitudinal direction of the driver's vehicle.

By the way, when a vehicle is running, various external factors can affect the acceleration of the vehicle. Thus is, various types of outside resistance are added to the vehicle when the vehicle is running. The acceleration control device estimates an acceleration component caused by the outside resistance, and adds the estimated acceleration component into the target acceleration, and determines the control value for the drive torque or the damping torque which is generated by the feed forward control (FF control) of the vehicle.

One of the external factors affecting the acceleration of the vehicle is an acceleration component (hereinafter, also referred to as the “gradient acceleration”) which is generated by the acceleration of gravity and given to the driver's vehicle when the driver's vehicle is running (and also stopped) on a road with an inclination or a slope.

There is a known method to calculate the gradient acceleration by subtracting the wheel acceleration, every transferred from the wheel speed sensor, from the total acceleration.

However, because the wheel acceleration is different from the actual acceleration in the longitudinal direction of the driver's vehicle when the driving state of the driver's vehicle is in the transition state, the gradient acceleration obtained by the above calculation method is different in general from the actual gradient acceleration actually given to the driver's vehicle.

This causes a problem for the conventional acceleration control device and makes it difficult to calculate the acceleration component when it estimates the acceleration caused by the gradient acceleration which is different from the actual gradient acceleration.

In other words, the conventional acceleration control device has a problem to generate more drive torque than required or less damping torque than required when the driver's vehicle is in the transition state.

In accordance with the second aspect of the present invention, there is provided the acceleration control device in order to solve the conventional problem previously described.

The acceleration control device has a total acceleration obtaining means, and a gradient acceleration calculation means. The total acceleration obtaining means gets a total acceleration. The gradient acceleration calculation means calculates the gradient acceleration by subtracting the wheel acceleration from the total acceleration obtained by the total acceleration obtaining means, and outputs the gradient acceleration.

The total acceleration of the driver's vehicle expresses a total acceleration which includes an acceleration of gravity given to the driver's vehicle detected by the acceleration sensor. The acceleration of gravity is given to the driver's vehicle.

The acceleration control device according to the second aspect of the present invention has a control acceleration calculation means that calculates a control acceleration which is obtained by adding the gradient acceleration obtained by the gradient acceleration calculation means to the target acceleration calculated by the target acceleration calculation means.

The drive control means performs the drive control to generate the control acceleration in the driver's vehicle according to the control acceleration calculated by the control acceleration calculation means.

In particular, the acceleration control device according to the present invention has a gradient acceleration maintaining means that performs an acceleration maintain control to maintain, as the output value during the period of the transition state, the gradient acceleration calculated at the timing to shift the driving state of the driver's vehicle to the transition state by the gradient acceleration calculation means when the detection result of the drive state detection means indicates that the driving state of the driver's vehicle is shifted to the transition state.

That is, because the transition state is a state of a very short time period immediately before vehicle stop or immediately after vehicle start, it is unlikely that the inclination of the road on which the driver's vehicle is running is significantly changed within the very short time period in the transition state and the drive state immediately before the transition state.

Accordingly, it can be said that the gradient acceleration at the time when the driver's vehicle is shifted to the transition state becomes approximately equal to the actual gradient acceleration during the transition state of the driver's vehicle. In other words, the acceleration control device of the present invention can prevent the acceleration in the longitudinal direction of the driver's vehicle from becoming greatly different from the actual acceleration in the longitudinal direction.

Because the acceleration control device of the present invention does not calculate the control acceleration based on the gradient acceleration which is different from the actual gradient acceleration, it is possible to avoid the generation of more drive torque than required or less damping torque than required.

A vehicle equipped with the acceleration control device of the present invention can provide the improved conformable driving to the passengers and driver of the vehicle.

In accordance with a second aspect of the present invention, there is provided an acceleration control device having the following modification.

The acceleration control device has a wheel speed obtaining means, a wheel acceleration obtaining means, a total acceleration obtaining means, a gradient acceleration calculation means, a control acceleration calculation means, a drive control means, a drive state detection means, and a gradient acceleration maintaining means.

The wheel speed obtaining means obtains the wheel speed, the wheel acceleration obtaining means obtains the wheel acceleration, the total acceleration obtaining means obtains the total acceleration, and the gradient acceleration calculation means obtains the gradient acceleration by subtracting the wheel acceleration from the total acceleration, and outputs the gradient acceleration.

The control acceleration calculation means calculates the control acceleration by adding the gradient acceleration obtained by the gradient acceleration calculation means to the target acceleration calculated by the target acceleration calculation means. The drive control means generates the control acceleration in the driver's vehicle according to the control acceleration calculated by the control acceleration calculation means

The drive state detection means detects the driving state of the driver's vehicle, where the drive state includes at least a timing to shift the driving state of the driver's vehicle to the transition state based on the wheel speed. According to the second aspect of the present invention, it is necessary for the gradient acceleration maintaining means to maintain, as the output value during the period of the transition state, the gradient acceleration calculated at the time when the driver's vehicle enters the transition state by the gradient acceleration calculation means when the detection result of the drive state detection means indicates that the driving state of the driver's vehicle is shifted to the transition state.

Because the acceleration control device of the second aspect of the present invention does not calculate the control acceleration by using the gradient acceleration which is different from the actual gradient acceleration, it is possible to prevent any generation of the drive torque more than required or the damping torque less than required in the driver's vehicle.

As a result, the vehicle equipped with the acceleration control device according to the second aspect of the present invention can provide improved comfortable driving to the passengers and driver of the vehicle.

It is possible for the gradient acceleration maintaining means to determine, as the period of the transition state, a period counted from the timing when the driving state of the driver's vehicle enters the transition state to the timing when a predetermined time length is elapsed.

In accordance with a third aspect of the present invention, there is provided an acceleration control device comprised of a target acceleration calculation means, a feedback control means, a wheel speed obtaining means, a wheel acceleration obtaining means, a total acceleration obtaining means, a drive state detection means, and a acceleration calculation means. The acceleration calculation means has a gradient acceleration calculation means and a gradient acceleration maintaining means.

The target acceleration calculation means calculates a target acceleration in order to control a driving state of a driver's vehicle to a target drive state. The feedback control means performs a feedback control of a brake torque or a damping torque generated in the driver's vehicle so that the wheel acceleration in the longitudinal direction of the driver's vehicle becomes equal to the target acceleration.

The acceleration in the longitudinal direction is an acceleration given to the driver's vehicle in the longitudinal direction thereof.

In the acceleration control device according to the third aspect of the present invention, the wheel speed obtaining means obtains the wheel speed of the driver's vehicle, the wheel acceleration obtaining means obtains the wheel acceleration of the driver's vehicle, the total acceleration obtaining means obtains the total acceleration of the driver's vehicle, and the drive state detection means detects the driving state of the driver's vehicle. The drive state includes at least a timing to shift the driving state of the driver's vehicle to the transition state based on at least the wheel speed obtained by the wheel speed obtaining means. When the detection result indicates that the driving state of the driver's vehicle is shifted to the transition state, the acceleration calculation means calculates the acceleration in the longitudinal direction of the driver's vehicle during the transition state based on the wheel acceleration and the total acceleration.

In particular, the gradient acceleration calculation means in the acceleration calculation means calculates a gradient acceleration by subtracting the wheel acceleration at the time when the driver's vehicle enters the transition state from the total acceleration at the time when the driver's vehicle enters the transition state. The gradient acceleration maintaining means in the acceleration calculation means maintains the gradient acceleration calculated by the gradient acceleration calculation means. The acceleration control device outputs as the acceleration in the longitudinal direction of the driver's vehicle, a value obtained by subtracting the maintained gradient acceleration from the total acceleration, every transferred from the total acceleration obtaining means.

Because the transition state is a state in a very short time period immediately before vehicle stop or immediately after vehicle start, it is unlikely that the gradient of the gradient of the road on which the driver's vehicle is running is significantly varied when the driving state of the driver's vehicle is shifted to the transition state.

Therefore the gradient acceleration on entering the transition state is approximately equal to the gradient acceleration of the driver's vehicle during the transition state. That is, the actual acceleration in the longitudinal direction of the driver's vehicle is approximately equal to the gradient acceleration which is obtained by subtracting the gradient acceleration maintained by the gradient acceleration maintaining means from the total acceleration, every transferred from the total acceleration obtaining means.

In other words, it is possible for the acceleration control device of the third aspect of the present invention to avoid calculating and outputting an acceleration in the longitudinal direction which is different from the actual acceleration in the longitudinal direction.

This makes it possible for the acceleration control device of the third aspect of the present invention to avoid performing the feedback control using the acceleration in the longitudinal direction which is different from the actual acceleration in the longitudinal direction. This makes it possible to prevent more drive torque than required or less damping torque than required from being generated in the driver's vehicle. This provides improved comfortable driving to the passengers and driver of the vehicle during the transition state.

In the acceleration control device according to the third aspect of the present invention, the acceleration calculation means determines, as the period of the transition state, a period counted from the timing when the driving state of the driver's vehicle enters the transition state to the timing when a predetermined time length is elapsed.

By the way, when the driver's vehicle stops, the actual speed of the driver's vehicle is gradually decreased and finally equals to the minimum detection speed. In the state immediately after this, there is a high probability that the wheel speed of the driver's vehicle is different from the actual acceleration in the longitudinal direction of the driver's vehicle, and the driver's vehicle thereby enters the transition state.

In the acceleration control device according to the third aspect of the present invention, the drive state detection means determines the timing for the driver's vehicle to enter the transition state when the wheel speed of more than a minimum detection speed of the wheel speed sensor becomes equal to the minimum detection speed.

In the acceleration control device described above, even if the driver's vehicle decelerates, and then enters the state immediately before vehicle stop (one of the transition states), it is possible to prevent more damping torque than required (or less than required) from being generated in the driver's vehicle.

When the driver's vehicle starts and is accelerated, the actual wheel speed is changed from 0 km/h to a value of more than the minimum detection speed of the wheel speed sensor. The actually detected wheel speed value is 0 km/h and the wheel acceleration is 0 m/s² until the actual wheel speed becomes equal to the minimum detection wheel speed.

However, because the driver's vehicle has already started, acceleration is given to the driver's vehicle in the longitudinal direction thereof, and there is therefore probability that the actual acceleration in the longitudinal direction is different from the wheel acceleration.

The drive state detection means in the acceleration control device of the third aspect of the present invention determines the timing to shift the driver's vehicle to the transition state when a stop-state value of the driver's vehicle is changed to a start-state value of the driver's vehicle.

According to the acceleration control device having the above structure, even if the driver's vehicle is in the transition state immediately after vehicle stop (one of the transition states), it is possible to prevent more drive torque than required (or less than required) from being generated in the driver's vehicle.

The stop-state value indicates the stop state of the driver's vehicle, for example, a value within a range from 0 m/s² to a predetermined value. The start-state value expresses that the driver's vehicle starts, for example, from a value of not less than a predetermined value which includes 0 m/s².

When the driver's vehicle starts and is accelerated, the set time period is continued after the timing when the agreement of the wheel acceleration becomes equal to the actual acceleration in the longitudinal direction (that is, at the timing when the actually-detected wheel speed reaches the minimum detection value). It is therefore preferable to use a period obtained by adding the set time period to the period until the actual wheel speed is equal to the minimum detection speed, as the period of the transition state (that is, the set time period) after the state immediately after vehicle start.

In the acceleration control device according to the third aspect of the present invention, the drive state detection means determines the timing for the driver's vehicle to enter the transition state when the predetermined time period is elapsed, which is counted from the time when the wheel speed of more than a minimum detection speed of the wheel speed sensor becomes equal to the minimum detection speed.

According to the acceleration control device according to the present invention, it is possible to calculate the acceleration in the longitudinal direction as the gradient acceleration even if the driver's vehicle is running on the road with an inclination along the longitudinal direction of the driver's vehicle.

### BRIEF DESCRIPTION OF THE DRAWINGS

A preferred, non-limiting embodiment of the present invention will be described by way of example with reference to the accompanying drawings, in which:

FIG. 1 is a view schematically showing a vehicle equipped with a cruise assist system which has a cruise assist ECU (as acceleration control device) according to the present invention;

FIG. 2 is a block diagram showing a schematic configuration of the cruise assist system having the cruise assist ECU shown in FIG. 1;

FIG. 3 is a block diagram showing a schematic configuration of the cruise assist ECU according to a first embodiment of the present invention;

FIG. 4 is a view showing a transition of the driving state of the vehicle shown in FIG. 1;

FIG. 5A is a flow chart showing the process of the cruise assist ECU to calculate a reliable wheel acceleration value during the running state of the vehicle;

FIG. 5B is a flow chart showing the process of the cruise assist ECU to calculate the reliable wheel acceleration value during the drive state immediately before vehicle stop;

FIG. 6A is a flow chart showing the process of the cruise assist ECU to calculate the reliable wheel acceleration value during vehicle stop;

FIG. 6B is a flow chart showing the process of the cruise assist ECU to calculate the reliable wheel acceleration value during the drive state immediately after vehicle starts;

FIG. 7 is a flow chart showing the process of the cruise assist ECU to calculate an estimated gradient acceleration of the vehicle;

FIG. 8 is a flow chart showing the process of the cruise assist ECU to adjust (or compensate) a FB torque gain;

FIG. 9A to FIG. 9D show relationships between a requested acceleration aⱼₗₘₜ after jerk limitation, a wheel speed V_{act}, a wheel acceleration a_{act}, a reliable wheel acceleration value Qᵣₑ of the wheel acceleration of the driver's vehicle, and elapse of time;

FIG. 10 is a block diagram showing a schematic configuration of the cruise assist system having the cruise assist ECU according to a second embodiment of the present invention;

FIG. 11A is a flow chart showing the process of the cruise assist ECU to calculate a proposed wheel acceleration during the running state of the vehicle;

FIG. 11B is a flow chart showing the process of the cruise assist ECU to calculate the proposed wheel acceleration during the drive state immediately before vehicle stop;

FIG. 12A is a flow chart showing the process of the cruise assist ECU to calculate the proposed wheel acceleration when vehicle stop;

FIG. 12B is a flow chart showing the process of the cruise assist ECU to calculate the proposed wheel acceleration during the drive state immediately after vehicle start;

FIG. 13A to FIG. 13D show relationships between a requested acceleration aⱼₗₘₜ after jerk limitation, a wheel speed V_{act}, a wheel acceleration a_{act}, a total acceleration a_{g}, a gradient component acceleration, a proposed wheel acceleration a_{mod}, and an elapse of time; and

FIG. 14 is a view which explanatory shows a conventional problem caused in a conventional adaptive cruise control device.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Embodiment

A description will be given of the cruise assist system 1 equipped with a cruise assist ECU 20 (as acceleration control device) according to a first embodiment of the present invention.

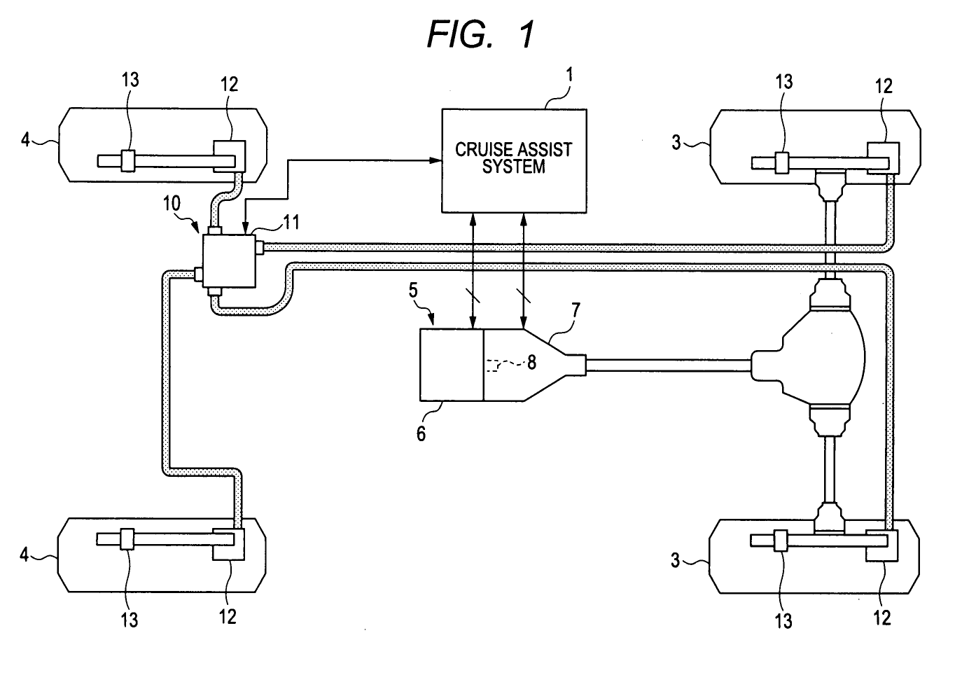

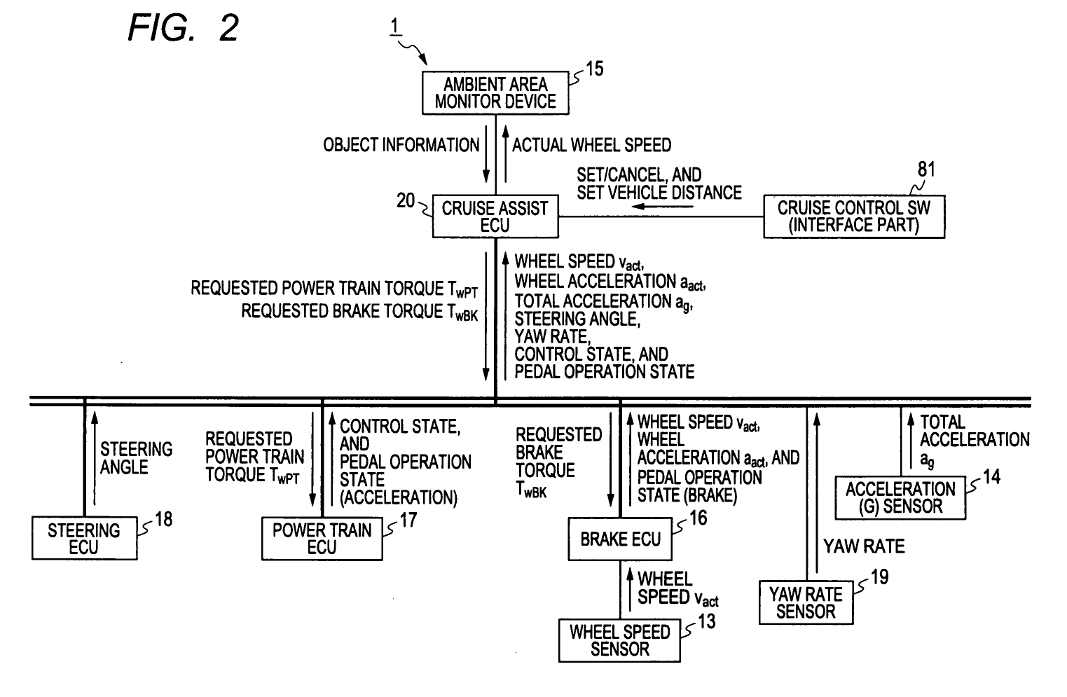

FIG. 1 is a view schematically showing a vehicle (driver's vehicle) equipped with the cruise assist system 1 according to the present invention. The cruise assist system 1 has the cruise assist ECU 20 according to the first embodiment of the present invention. FIG. 2 is a block diagram showing a schematic configuration of the cruise assist system 1 having the cruise assist ECU 20 shown in FIG. 1.

Hereinafter, a vehicle equipped with the cruise assist system 1 having the cruise assist ECU 20 will be referred to as the “driver's vehicle”.

As shown in FIG. 1, the driver's vehicle has at least a power train mechanism 5, a brake mechanism 10, and a cruise assist system 1. The cruise assist system 1 controls the power train mechanism 5 and the brake mechanism 10 in order to assist the driving of the driver's vehicle.

The power train mechanism 5 is comprised of an internal combustion engine 6 as a power source of the driver's vehicle, and a transmission mechanism 7. The transmission mechanism 7 is a clutch and a plurality of gears which are connected to a crank shaft 8 of the internal combustion engine 6. The transmission mechanism 7 is a well known device.

The brake mechanism 10 has a known device comprised of wheel cylinders 12 and a brake actuator 11. The wheel cylinders 12 are attached to wheels such as drive wheels 3 and driven wheels 4 of the driver's vehicle. The brake actuator 11 controls the open and close of control valves in order to increase or decrease an oil pressure of brake oil in a brake oil circuit to supply working fluid to the wheel cylinders 12.

### <Cruise Assist System>

A description will now be given of the cruise assist system 1 equipped with the cruise assist ECU 20 according to the first embodiment of the present invention. The cruise assist ECU 20 corresponds to the acceleration control device according to the present invention.

The cruise assist system 1 performs an adaptive cruise control (such as “ACC”) which controls the power train mechanism 5 and the brake mechanism 10 so that a vehicle distance between the driver's vehicle and one (as a target vehicle) of front vehicles which are running in front of the driver's vehicle is maintained at a predetermined distance (as a target vehicle distance).

As shown in FIG. 2, the cruise assist system 1 is an ambient scene monitor device 15 to detect objects which are placed in the surrounding area (for example, the front area) of the driver's vehicle. The ambient scene monitor device 15 is connected to the cruise assist ECU 20.

The cruise assist ECU 20 is connected to at least a brake ECU (brake electric control unit) 16, a power train ECU 17, and a steering ECU 18.

Each of the brake ECU 16, the power train ECU 17, and the steering ECU 18 is composed mainly of a microcomputer equipped with a read only memory (ROM), a random access memory (RAM), and a central processing unit (CPU). The ROM stores data and processing programs, and can maintain them even if the supply of electric power is halted. The RAM temporarily stores data generated in the process of the programs stored in the ROM. The CPU executes the programs stored in the ROM and RAM. Each of the ECU 16, 17, and 18 is equipped with a bus controller through which various data items such as detection signals and calculation data are transferred between other devices and each of the ECU through a communication bus in a local area network (LAN).

The ambient scene monitor device 15 is comprised of a milliwave radar device of FMCW type. This ambient scene monitor device 15 receives data regarding a vehicle speed (or a wheel speed) of the driver's vehicle at this moment transferred from the cruise assist ECU 20.

Further, the ambient scene monitor device 15 detects various types of objects such as front vehicles including the target vehicle and outdoor objects (for example, guardrails and traffic signals) based on continuous millimeter wave signals which are obtained by frequency modulation, and makes the object information regarding the front vehicles and outdoor objects. The ambient scene monitor device 15 transfers the object information to the cruise assist ECU 20. The object information includes at least a relative speed between the driver's vehicle and the object, and the position (distance and direction) of the object.

The brake ECU 16 transfers a wheel speed V_{act}, a wheel acceleration a_{act}, and brake operation data to the cruise assist ECU 20. The wheel speed V_{act} and the wheel acceleration a_{act} are obtained based on detection signals transferred from the wheel speed sensors 13. The brake operation data is obtained based on detection information transferred from a master cylinder (M/C) pressure sensor.

The wheel sensors 13 are attached to the drive wheel 3 and the driven wheels 4, respectively. Each of the wheel sensors 13 is a known sensor to generate, a detection signal in pulse form depending on the rotation of the wheels 3 and 4. Therefore the brake ECU 16 detects the number of pulses in the detection pulse signal every predetermined interval of time, and calculates the rotation angle of each of the wheels 3 and 4 and the wheel speed based on the number of pulses in the detection pulse signal.

Further, the brake ECU 16 differentiates the calculated wheel speed in order to obtain a wheel acceleration. The calculated wheel acceleration is provided into a primary filter, and the value passed through the primary filter is then transferred to the cruise assist ECU 20.

Hereinafter, an average value of the calculated wheel speeds of the wheels 3 and 4 is the wheel speed V_{act}, and an average value of the calculated wheel acceleration of the wheels 3 and 4 is the wheel acceleration a_{act}.

When receiving a request brake torque T_{wBK} transferred from the cruise assist ECU 20, the brake ECU 16 drives the brake actuator 11 mounted in the break mechanism 10 according to the received request brake torque T_{wBK}, where the brake request torque T_{wBK} expresses the magnitude of a brake torque which is generated by the brake mechanism 10. That is, the brake ECU 16 instructs the brake mechanism 10 to generate the damping torque according to the request brake torque T_{wBK} transferred from the cruise assist ECU 20.

The power train ECU 17 transfers to the cruise assist ECU 20 various state information (such as engine control state and acceleration pedal operation state) transferred from throttle opening sensor (not shown) and acceleration pedal opening sensor (not shown).

Further, the power train ECU 17 receives the request power train torque T_{wPT} transferred from the cruise assist ECU 20. The request power train torque T_{wPT} expresses the magnitude of the drive torque or damping torque which is generated by the power train mechanism 5.

The power train ECU 17 generates and outputs a drive instruction and a change instruction based on the request power train torque T_{wPT} and outputs them to the throttle actuator and the transmission mechanism 7, respectively. When receiving the drive instruction, the throttle actuator adjusts the degree of opening of the throttle. When receiving the change instruction, the transmission mechanism 7 changes its gear ratio. That is, the power train ECU 17 generates the drive torque or the damping torque according to the request power train torque T_{wPT} transferred from the cruise assist ECU 20.

The steering ECU 18 receives a detection signal (that is, a steering angle or wheel angle) transferred from a steering angle sensor (not shown) to detect the steering angle of the wheels, and transfers the steering angle to the cruise assist ECU 20. The steering ECU 18 performs the power steering control to generate the assist power when the steering wheel changes the steering angle.

By the way, the cruise assist ECU 20 is connected to at least a cruise control switch 81 through which the driver of the vehicle inputs a vehicle distance to the cruise assist ECU 20. The cruise assist ECU 20 receives a yaw rate, which is given to the driver's vehicle, transferred from a yaw rate sensor 19, and further receives a total acceleration (hereinafter, referred to as the “total acceleration a_{g}”), transferred from the acceleration sensor 14, where the total acceleration a_{g} includes an acceleration of gravity which is applied to the driver's vehicle by the slope of the driving road.

The cruise control switch 81 serves as an interface part which is composed of a setting switch (not shown), a canceling switch (not shown), and a vehicle distance input part through which the driver of the vehicle inputs a vehicle distance to maintain the vehicle distance between the driver's vehicle and the target vehicle. The driver starts and also completes various controls (ACC in the first embodiment) through the setting switch and the canceling switch.

The acceleration sensor (G sensor) 14 is a known sensor which is composed of a box which stores liquid therein. The acceleration sensor 14 detects a slope of the liquid surface of the liquid in the box to the horizontal line to detect a total acceleration a_{g}.

That is, the total acceleration a_{g} detected by the acceleration sensor 14 becomes only an acceleration given in the longitudinal direction of the driver's vehicle when the driver's vehicle is running on a flat road without any inclination (or any slope). For example, the total acceleration a_{g} detected by the acceleration sensor 14 is an acceleration which is a combination of:

an acceleration in the longitudinal direction of the driver's vehicle when the driver's vehicle is running on a flat road without any inclination; and an acceleration of gravity which is given to the driver's vehicle when the driver's vehicle runs with an acceleration on a road with an inclination.

### <Cruise Assist ECU>

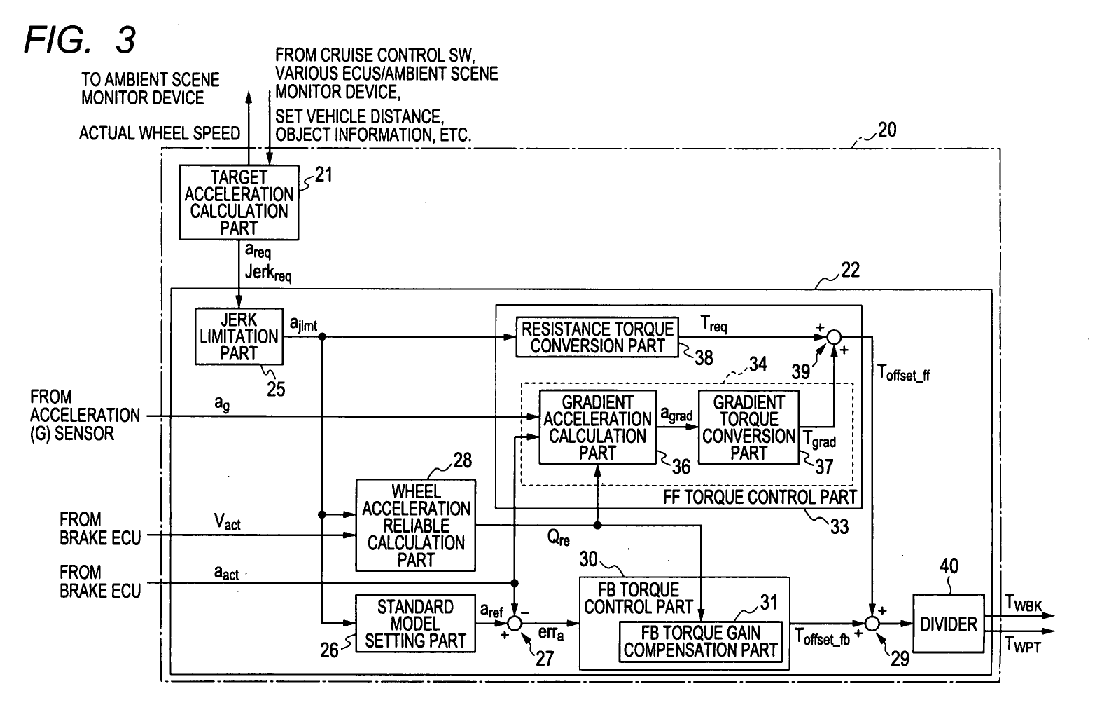

A description will now be given of the cruise assist ECU 20 in the cruise assist system 1 according to the first embodiment of the present invention with reference to FIG. 3.

FIG. 3 is a block diagram showing a schematic configuration of the cruise assist ECU 20 according to the first embodiment of the present invention shown in FIG. 2.

As shown in FIG. 3, the cruise assist ECU 20 serves as a target acceleration calculator 21 to repeatedly calculate an acceleration (target acceleration a_{req}) which is required to maintain the vehicle distance between the target vehicle and the driver's vehicle at the request vehicle distance. Further, the cruise assist ECU 20 serves as the acceleration controller 22 to calculate the request power train torque T_{wPT} and the request brake torque T_{wBK} according to the calculated target acceleration a_{req}.

When receiving a detection signal which indicates the turned-on (set-on signal) of the setting switch in the cruise control switch 81, the target acceleration calculator 21 starts the repetition process of an application program to execute the adaptive cruise control every predetermined period.

Hereinafter, the cruise assist ECU 20 which serves as the target acceleration calculator 21 is referred to as the “target acceleration calculator 21”, and the cruise assist ECU 20 which serves as the acceleration controller 22 is referred to as the “acceleration controller 22”

The target acceleration calculator 21 calculates the target acceleration a_{req} and a request jerk limitation value Jerk_{req} based on various types of input information. The request jerk limitation value Jerk_{req} is a limitation value to prevent the target acceleration a_{req} calculated every a predetermined timing from varying out of a predetermined range (that is, prevent a difference between the target accelerations a_{req} from becoming not less than a predetermined value).

That is, the target acceleration calculator 21 repeatedly performs the application program every predetermined timing period in order to calculate the target acceleration a_{req}, and the request jerk limitation value Jerk_{req}, and outputs them to the acceleration controller 22.

### <Acceleration Controller 22>

A description will now be given of the acceleration controller as one of main components of the cruise assist ECU 20 in the cruise assist system 20 according to the first embodiment of the present invention.

The acceleration controller 22 performs the application program every a set timing which is shorter in time period than the predetermined timing in order to calculate and output the request power train torque T_{wPT}, the request brake torque T_{wBK}.

The acceleration controller 22 is composed of a jerk limitation part 25 and a standard model setting part 26.

The jerk limitation part 25 calculates a requested acceleration aⱼₗₘₜ after jerk limitation which is obtained by limiting the target acceleration a_{req}, which is output from the target acceleration calculator 21 every predetermined timing, within a predetermined range.

The standard model setting part 26 generates a standard response acceleration a_{ref} by inputting the requested acceleration aⱼₗₘₜ after jerk limitation transferred from the jerk limitation part 25 into a standard model composed of a first lag primary delay model.

The standard response acceleration a_{ref} becomes a necessary acceleration to achieve the requested acceleration aⱼₗₘₜ after jerk limitation under an ideal condition (that is, without any external factors) by the power train mechanism 5 or the brake mechanism 10.

The acceleration controller 22 is composed of a wheel acceleration reliable calculation part 28 and a FF torque control part 33.

The wheel acceleration reliable calculation part 28 sets a reliable wheel acceleration value Qre which expresses the possibility of the wheel acceleration a_{act} which is different from an actual acceleration in the longitudinal direction of the driver's vehicle. The FF torque control part 33 calculates a feed forward control value to adjust or compensate a decreased part of the drive torque generated by a resistance component which is given to the driver's vehicle.

The actual acceleration in the longitudinal direction of the driver's vehicle is an acceleration given to the driver's vehicle in the longitudinal direction of the driver's vehicle. This actual acceleration has a positive value when the driver's vehicle is accelerated, and a negative value when the driver's vehicle is decelerated.

The acceleration controller 22 has an acceleration deviation calculation part 27 and a feed back (FB) torque control part 30.

The acceleration deviation calculation part 27 calculates a difference (hereinafter, referred to as the “acceleration deviation err_{—}_{^{a}}”) between the standard response acceleration a_{ref} generated by the standard model setting part 26 and the wheel acceleration a_{act} from the brake ECU 16.

In addition, the acceleration controller 22 has a control torque calculation part 29 and a divider 40. The control torque calculation part 29 calculates a sum (hereinafter, referred to as the “control torque Tw”) of the FB torque T_{offset}_{_{—}}_{fd} and the FF control value (T_{offset}_{_{—}}_{ff} shown in FIG. 3) calculated by the FF torque control part 33. The divider 40 divides the control torque Tw calculated by the control torque calculation part 29 into the request power train torque T_{wPT} and the request brake torque T_{wBK} according to a predetermined condition

### <Wheel Acceleration Reliable Calculation Part 28>

A description will now be given of the wheel acceleration reliable calculation part 28 in the cruise assist ECU 20.

The wheel acceleration reliable calculation part 28 sets, to the reliable wheel acceleration value Qᵣₑ, one of a transition-state value, a running -state value, and a stop-state value based on the wheel speed V_{act} from the brake ECU 16 and a requested acceleration aⱼₗₘₜ after jerk limitation from the jerk limitation part 25.

The transition-state value, the running-state value, and the stop-state value indicate the transition state of the driver's vehicle, the running state of the driver's vehicle, and the stop state of the driver's vehicle, respectively.

In particular, the driving state of the driver's vehicle is a state where the driver's vehicle is running at the vehicle speed which is greater than a speed detected by the resolution of a wheel speed sensor. The minimum speed detected by the wheel speed sensor will be referred to as the “minimum detection speed Vₘᵢₙ”). The stop state indicates that the driver's vehicle is stopped.

On the other hand, the transition state has two states, that is, the drive state immediately before vehicle stop and the drive state immediately after vehicle start.

The drive state immediately before vehicle stop is generated in a process from the running state to the stop state of the vehicle, and contains at least the state where the driver's vehicle is running at a lower speed than the minimum detection speed Vₘᵢₙ.

The drive state immediately after vehicle start is generated in a process from the stop state to the running state where the driver's vehicle is running at a lower speed of the minimum detection speed Vₘᵢₙ.

In other words, the transition state has a possibility that the wheel acceleration a_{act} is different from the actual acceleration in the longitudinal direction of the driver's vehicle.

The driving state and the stop state of the vehicle are the state having a possibility where the wheel acceleration a_{act} is different from the actual acceleration in the longitudinal direction of the driver's vehicle (that is, wheel acceleration a_{act} is approximately equal to zero).

The wheel acceleration reliable calculation part 28 can be realized by performing the process to calculate the reliable wheel acceleration value Qᵣₑ.

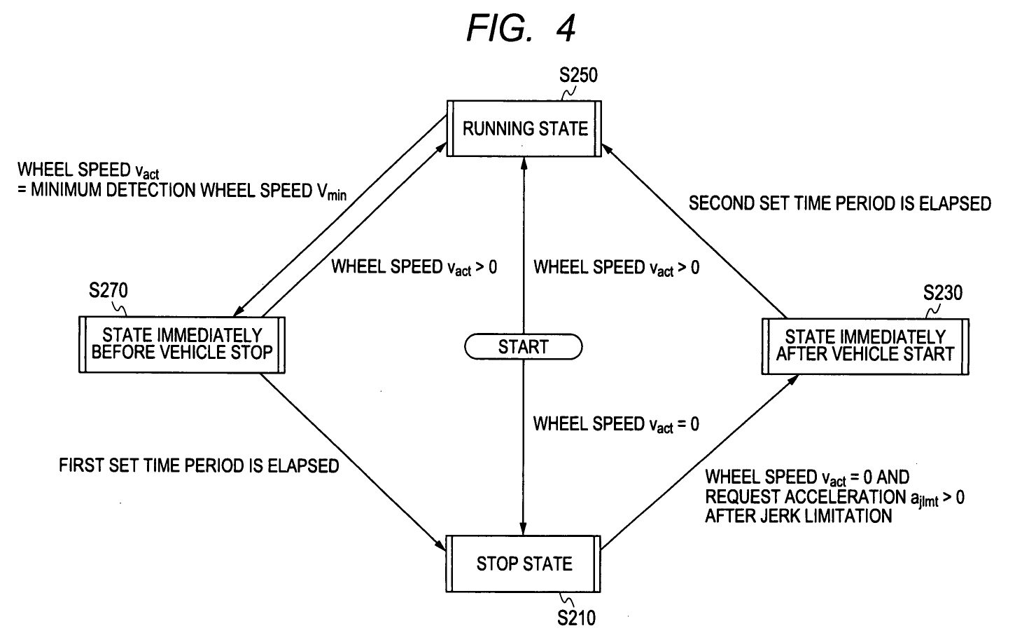

FIG. 4 is a view showing the transition of the driving state of the vehicle shown in FIG. 1 according to the driving state of the driver's vehicle.

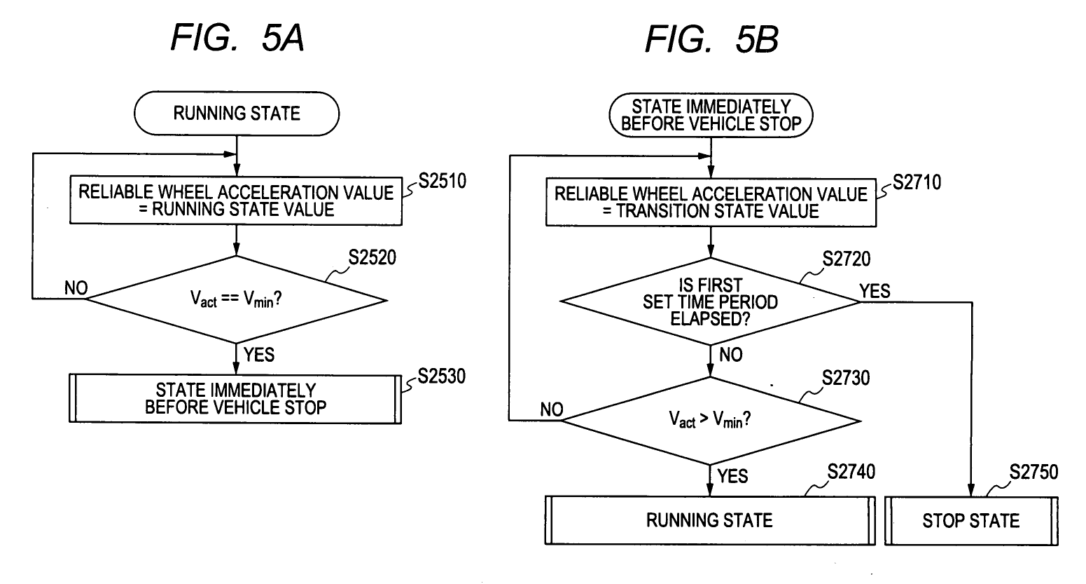

FIG. 5A is a flow chart showing the process of the cruise assist ECU 20 to calculate a reliable value of a wheel acceleration in the driving state of the vehicle. FIG. 5B is a flow chart showing the process of the cruise assist ECU 20 to calculate the reliable value of the wheel acceleration in the drive state immediately before vehicle stop.

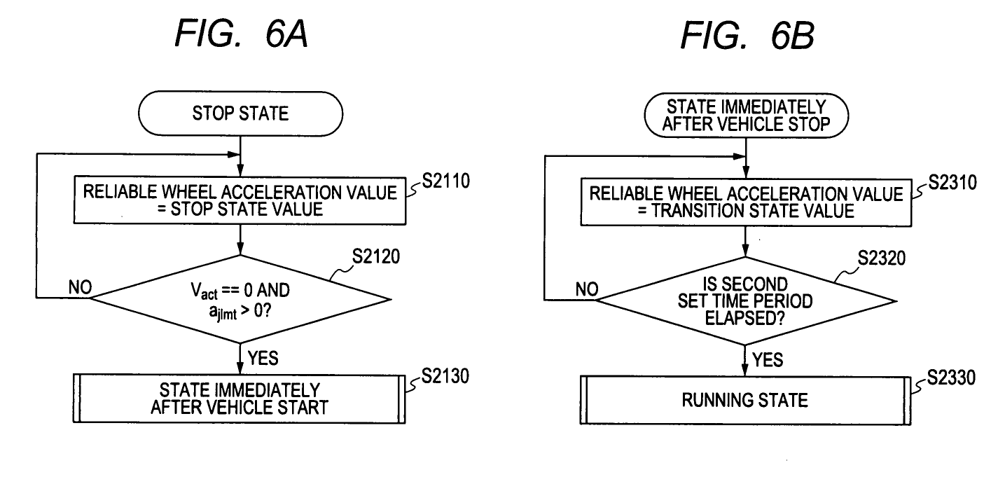

FIG. 6A is a flow chart showing the process of the cruise assist ECU 20 to calculate the reliable value of the wheel acceleration when the vehicle stops. FIG. 6B is a flow chart showing the process of the cruise assist ECU 20 to calculate the reliable value of the wheel acceleration in the drive state immediately after vehicle start.

The wheel acceleration reliable calculation part 28 in the cruise assist ECU 20 executes the process to calculate the reliable wheel acceleration value when receiving the set-on signal. That is, when receiving the set-on signal, the wheel acceleration reliable calculation part 28 executes this process and determines that the driver's vehicle is now stopped when the wheel speed V_{act} is not more than 0 km/h.

When the driver's vehicle is in the stop state, as shown in FIG. 6A, the wheel acceleration reliable calculation part 28 sets the stop-state value to the reliable wheel acceleration value Qᵣₑ (step S2110).

When the wheel speed V_{act} is 0 km/h, and the requested acceleration aⱼₗₘₜ after the jerk limitation is equal to 0 m/s² (“NO” in step S2120), the operation flow returns to step S2110. That is, the wheel acceleration reliable calculation part 28 sets the stop-state value to the reliable wheel acceleration value Qᵣₑ.

On the other hand, when the wheel speed Vact is 0 km/h, and the requested acceleration aⱼₗₘₜ after the jerk limitation is more than 0 m/s² (“YES” in step S2120), the cruise assist ECU 20 detects that the driving state of the driver's vehicle is changed to the drive state immediately after vehicle start (step S2130).

When the driver's vehicle enters the drive state immediately after vehicle start, the wheel acceleration reliable calculation part 28 sets the transition-state value to the reliable wheel acceleration value Qᵣₑ (step S2310), as shown in FIG. 6B.

When the requested acceleration aⱼₗₘₜ after the jerk limitation becomes more than 0 m/s², that is, when an elapse of time counted from the transition of the driving state of the driver's vehicle to the drive state immediately after vehicle start is less than a second set time, the wheel acceleration reliable calculation part 28 maintains the reliable wheel acceleration value Qᵣₑ of the transition-state value because of judging that the driving state of the driver's vehicle continues the drive state immediately after vehicle start.

On the other hand, when the elapse of time counted from the transition of the driving state of the driver's vehicle to the drive state immediately after vehicle start is not less than the second set time, the wheel acceleration reliable calculation part 28 judges that the driving state of the driver's vehicle is shifted to the running state (step S2330).

The second set time period is set in advance based on experiments for many vehicles. That is, vehicles have a different second set time period, respectively. The second set time period is the sum of a set time period and a time period counted from a time when the driving state of the driver's vehicle is shifted from the stop state to the drive state immediately after vehicle start (that is, the driver's vehicle starts to run) to a time when the wheel speed V_{act} is equal to the minimum detection speed Vₘᵢₙ.

The set time period is a time period to require convergence of the fluctuation of the wheel acceleration a_{act} in the elapse of time within a predetermined set time period when human body does not feel any change in acceleration of the driver's vehicle, that is, which is counted from the time when the wheel speed V_{act} is equal to the minimum detection speed Vₘᵢₙ. For example, vehicles have such a different set time period which is determined in advance based on experimental results and known Meister's vibration period curve (see Section V in “Automotive engineering manual”, Society of Automotive Engineer of Japan).

When the driver's vehicle is in the running state, as shown in FIG. 5A, the wheel acceleration reliable calculation part 28 sets the running-state value to the reliable wheel acceleration value Qᵣₑ.

When the reliable wheel acceleration value Qᵣₑ has the running-state value, the operation flow returns to step S2510 when the wheel speed V_{act} is equal to the minimum detection speed Vₘᵢₙ (“NO” in step S2520, for example, the wheels peed V_{act}>Vₘᵢₙ).

The wheel acceleration reliable calculation part 28 maintains the reliable wheel acceleration value Qᵣₑ of the running-state value.

On the other hand, when the vehicle speed V_{act} is equal to the minimum detection speed Vₘᵢₙ (“YES” in step S2520), the wheel acceleration reliable calculation part 28 judges that the driving state of the driver's vehicle is changed from the running state to the drive state immediately before vehicle stop (step S2530).

When the driver's vehicle is in the drive state immediately before vehicle stop, as shown in FIG. 5B, the wheel acceleration reliable calculation part 28 sets the transition-state value to the reliable wheel acceleration value Qᵣₑ (step S2710).

When the time period counted from the time when the driving state of the driver's vehicle is shifted to the transition state is less than a first set time period, and the wheel speed Vact transferred from the brake ECU 16 is smaller than the minimum detection speed Vₘᵢₙ (“NO” in step S2720, and “NO” in step S2730), the wheel acceleration reliable calculation part 28 maintains the reliable wheel acceleration value Qᵣₑ of the transition-state value because the driving state of the driver's vehicle continues the drive state immediately before vehicle stop.

On the other hand, when the vehicle speed V_{act} is equal to the minimum detection speed Vₘᵢₙ, that is, when the time period counted from when the driving state of the driver's vehicle is shifted to the transition state is not less than the first set time period (“YES” in step S2720), the wheel acceleration reliable calculation part 28 judges that the driving state of the driver's vehicle has been changed to the stop state (step S2750).

When the vehicle speed Vact transferred from the brake ECU 16 is greater than the minimum detection speed Vₘᵢₙ before the time period is less than the first set time period (“YES” in step S2730), the wheel acceleration reliable calculation part 28 judges that the driving state of the driver's vehicle has been changed to the running state (step S2740).

The first set time period is a time period to require convergence of the fluctuation of the wheel acceleration a_{act} in the elapse of time within a predetermined set time period when the passengers and driver does not feel any change in acceleration of the driver's vehicle, that is, which is counted from the time when the wheel speed V_{act} is equal to the minimum detection speed Vₘᵢₙ. (that is, when the driving state of the driver's vehicle is shifted to the drive state immediately before vehicle stop).

For example, vehicles have such a different first set time period which is determined in advance based on experimental results and known Meister's vibration period curve (see Section V, “Ride comfort of vehicle—Automotive engineering manual”, lines 26 to 47, page 5-103, Society of Automotive Engineer of Japan).

When receiving the set-on signal, the wheel acceleration reliable calculation part 28 starts the process to calculate the reliable wheel acceleration value. When the wheel speed V_{act} is more than 0 km/h at the timing to start, the wheel acceleration reliable calculation part 28 judges that the driver's vehicle is in the running state, that is, now running.

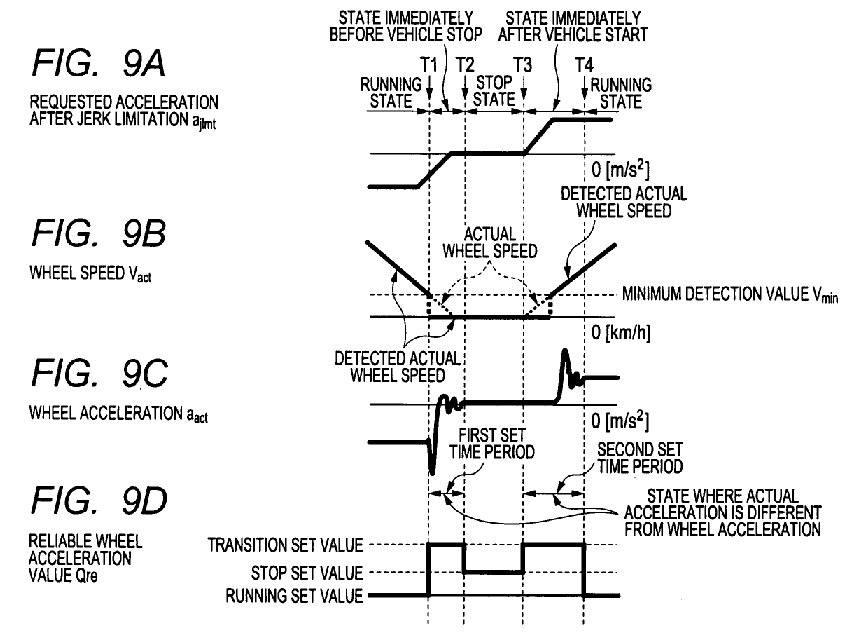

FIG. 9A to FIG. 9D show relationships between the requested acceleration aⱼₗₘₜ after jerk limitation, the wheel speed V_{act}, the wheel acceleration a_{act}, the reliable wheel acceleration value Qᵣₑ of the wheel acceleration, and an elapse of time.

That is, as shown in FIG. 9A to 9D, the wheel acceleration reliable calculation part 28 sets the transition-state value to the reliable wheel acceleration value Qᵣₑ at the timing T1 (see FIG. 9A to FIG. 9D) when the driving state of the driver's vehicle is shifted from the running state to the drive state immediately before vehicle stop when the wheel speed V_{act} becomes equal to the minimum detection speed Vₘᵢₙ.

In addition, the wheel acceleration reliable calculation part 28 maintains the reliable wheel acceleration value Qᵣₑ of the transition-state value during the period from the timing when the wheel speed V_{act} becomes equal to the minimum detection speed Vₘᵢₙ to the timing when the first set time period is elapsed, that is, during the drive state immediately before vehicle stop of the driver's vehicle (during the time period between T1 and T2 shown in see FIG. 9A to FIG. 9D).

Further, the wheel acceleration reliable calculation part 28 sets the transition-state value to the reliable wheel acceleration value Qᵣₑ when the wheel speed V_{act} is 0 km/h, and the requested acceleration aⱼₗₘₜ after jerk limitation becomes more than 0 m/s², that is, at the timing when the driving state of the driver's vehicle is shifted from the stop state to the drive state immediately after vehicle start (see T3 in FIG. 9A to FIG. 9D).

The wheel acceleration reliable calculation part 28 maintains the reliable wheel acceleration value Qᵣₑ of the transition-state value during the period when the second set time period is elapsed after the driving state of the driver's vehicle is shifted to the drive state immediately after vehicle start, that is, during the period when the driving state of the driver's vehicle is the drive state immediately after vehicle start (during the period between T3 and T4 in FIG. 9A to FIG. 9D).

When the driving state of the driver's vehicle becomes the stop state or the running state, the wheel acceleration reliable calculation part 28 sets the running-state value to the reliable wheel acceleration value Qᵣₑ at the timing when the rive state of the driver's vehicle is shifted to the running state. In addition, the wheel acceleration reliable calculation part 28 maintains the reliable wheel acceleration value Qᵣₑ of the stop-state value or the running-state value during the period when the driving state of the driver's vehicle is the stop state or the running state.

### <FF Torque Control Part>

A description will now be given of the FF (feed forward) torque control part in the cruise assist ECU 20 according to the first embodiment of the present invention.

As shown in FIG. 3, the FF torque control part 33 has a resistance torque conversion part 38, a gradient torque calculation part 34, and a FF torque calculation part 39.

The resistance torque conversion part 38 calculates a FF control value to each of an air resistance and a rolling resistance.

The gradient torque calculation part 34 calculates a FF control value due to a gradient resistance (or an inclination resistance, hereinafter, referred to as the “gradient resistance compensation torque T_{grad}”). The gradient resistance is specific resistance due to the component of gravitational force on a given gradient. If the slope of a road is downward in the direction of travel the value will be negative.

The FF torque calculation part 39 calculates a FF torque T_{offset#fb} adding the FF control value calculated by the resistance torque conversion part 38 and the gradient resistance compensation torque T_{grad} (FF control value) calculated by the gradient torque calculation part 34.

The FF control value due to the air resistance (that is, a compensation value of the drive torque or the damping torque) is referred to as the “air resistance compensation torque”.

The FF control value due to rolling resistance (that is, a compensation value of the drive torque (or damping torque) to rolling resistance is referred to as the “rolling resistance compensation torque”.

The resistance torque conversion part 38 calculates the air resistance compensation torque and the rolling resistance compensation torque by using the following equations (1) and (2), respectively.

Air resistance compensation torque=(ρ/2)Cd·A·V_{act}²×r (1),

Rolling resistance compensation torque=μMg×r (2),

where ρ is air density (kg/m³), Cd is an air resistance coefficient, A is a front projection area (m²) of the driver's vehicle, Vact is a wheel speed (m/s), μ is a rolling resistance coefficient, M is a weight (kg) of the driver's vehicle, g is the acceleration of gravity (m/s²), and r is a radius (m) of a drive wheel.

The gradient torque calculation part 34 has a gradient acceleration calculation part 36 and a gradient resistance torque conversion part 37.

The gradient acceleration calculation part 36 calculates the acceleration of gravity (hereinafter, referred to as the “gradient acceleration a_{grad}”) which is given to the driver's vehicle when the driver's vehicle runs on a road with an inclination.

The gradient resistance torque conversion part 37 calculates the gradient resistance compensation torque T_{grad} based on the gradient acceleration a_{grad} calculated by the gradient acceleration calculation part 36.

The gradient resistance torque conversion part 37 calculates the gradient resistance compensation torque T_{grad} based on the following equation (3):

Gradient resistance compensation torque T_{grad}=M·a_{grad}×r (3),

where a_{grad} is gradient acceleration calculated by the gradient acceleration calculation part 36, r is a radius (m) of a drive wheel. For example, the gradient resistance is specific resistance due to the component of gravitational force on a given gradient. If the slope of a road is downward in the direction of travel the value will be negative.

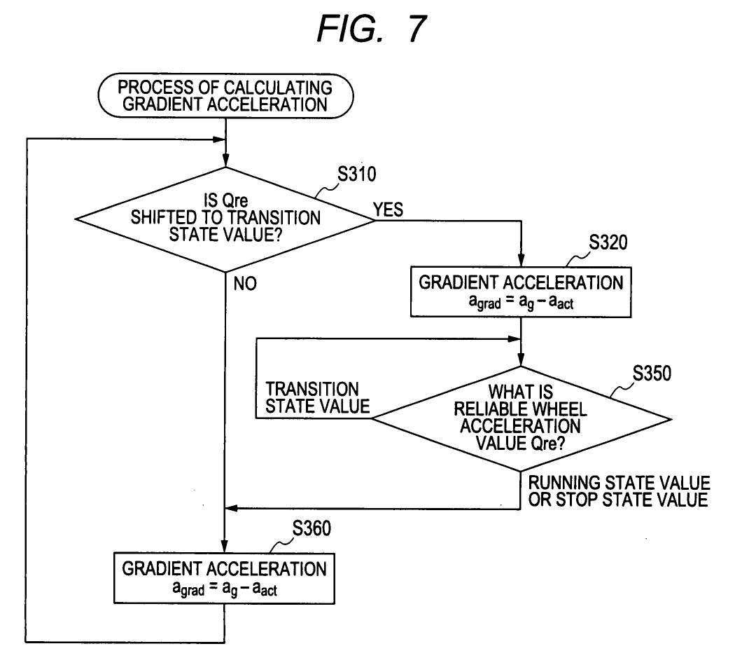

FIG. 7 is a flow chart showing the process of the cruise assist ECU 20 to calculate an estimated gradient acceleration of the vehicle. As shown in FIG. 7, the gradient acceleration calculation part 3 is achieved for the cruise assist ECU 20 to perform the process to calculate the gradient acceleration.

The gradient acceleration calculation part 36 detects whether or not the reliable wheel acceleration value Qᵣₑ calculated by the wheel acceleration reliable calculation part 28 is shifted to the transition-state value (step S310).

When the judgment result in step S310 indicates that the reliable wheel acceleration value Qᵣₑ has the transition-state value, the gradient acceleration calculation part 36 calculates the gradient acceleration a_{grad} by subtracting the wheel acceleration a_{act} from the sum acceleration a_{g} (step S320), where the wheel acceleration a_{act} is transferred from the brake ECU 16 at the timing when the reliable wheel acceleration value Qᵣₑ is changed to the transition-state value, and the total acceleration a_{g} is transferred from the acceleration sensor 14 when the reliable wheel acceleration value Qᵣₑ is changed to the transition-state value.

Further, when the reliable wheel acceleration value Qᵣₑ transferred from the wheel acceleration reliable calculation part 28 is maintained with the transition-state value, the gradient acceleration calculation part 36 waits to execute the process until the reliable wheel acceleration value Qᵣₑ is shifted from the transition-state value to the running-state value or the stop-state value (step S350, in the transition-state).

When the driving state of the driver's vehicle is in the drive state immediately before vehicle stop or the drive state immediately after vehicle start, this makes it possible to maintain the gradient acceleration a_{grad} without any change which is set at the timing when the reliable wheel acceleration value Qᵣₑ is changed to the transition-state value.

The gradient resistance torque conversion part 37 calculates the gradient resistance compensation torque T_{grad} based on the gradient acceleration a_{grad} which is maintained.

When the reliable wheel acceleration value Qᵣₑ transferred from the wheel acceleration reliable calculation part 28 is changed from the transition-state value to the running-state value or the stop-state value (“running-state value or stop-state value” in step S350), the operation flow progresses to step S360.

On the other hand, when the judgment result in step S310 indicates that the reliable wheel acceleration value Qᵣₑ transferred from the wheel acceleration reliable calculation part 28 has the running-state value or the stop-state value, the operation flow progresses to step S360. That is, when the reliable wheel acceleration value Qᵣₑ transferred from the wheel acceleration reliable calculation part 28 is in the transition-state value to the running-state value or the stop-state value, the operation flow progresses to step 5360.

In step S360, the gradient acceleration calculation part 36 calculates the gradient acceleration a_{grad} by subtracting the wheel acceleration a_{act} from total acceleration a_{g}, every transferred from the acceleration sensor 14. The operation flow returns to step S310. In step S310, the gradient resistance torque conversion part 37 calculates the gradient resistance compensation torque T_{grad} based on the gradient acceleration a_{grad}, every calculated by the gradient acceleration calculation part 36.

That is, the gradient acceleration calculation part 36 repeatedly calculates the gradient acceleration a_{grad} based on the total acceleration a_{g} and the wheel acceleration a_{act}, every transferred while the driving state of the driver's vehicle is the running state or the stop state of the driver's vehicle.

The gradient acceleration calculation part 36 calculates the gradient acceleration a_{grad} based on the total acceleration a_{g} and the wheel acceleration a_{act} which are received at the timing when the driving state of the driver's vehicle is shifted from the running state to the drive state immediately before vehicle stop or from the stop state to the drive state immediately after vehicle start. At the same time, the gradient acceleration calculation part 36 stores the gradient acceleration a_{grad} (and outputs the gradient acceleration a_{grad} to the gradient resistance torque conversion part 37), which is calculated at the timing when the driving state of the driver's vehicle is shifted from the running state to the drive state immediately before vehicle stop or from the stop state to the drive state immediately after vehicle start, during the drive state immediately before vehicle stop or the drive state immediately after vehicle start.

### <FB Torque Control Part 30>

A description will now be given of the FB (feedback) torque control part 30 in the cruise assist ECU 20.

The FB torque control part 30 calculates a FB torque T_{offset}_{_{—}}_{fb} by providing an acceleration error err_{—}_{^{a}} to a PID control model. The acceleration error err_{—}_{^{a}} is calculated by the acceleration deviation calculation part 27.

This PID control model calculates a proportional component (P), a integration component (I), and a differential component (D) based on the acceleration error err_{—}_{^{a}}, and outputs the FB torque T_{offset}_{_{—}}_{fb} which is the sum of:

a value obtained by multiplying the proportional component (P) with a control gain;

a value obtained by multiplying the integration component (I) with the control gain; and

a value obtained by multiplying the differential component (D) with the control gain.

The above control gain will be referred to as the “FB torque gain”.

The FB torque control part 30 has a FB torque gain compensation part 31 which adjusts the FB torque gain according to the driving state of the driver's vehicle.

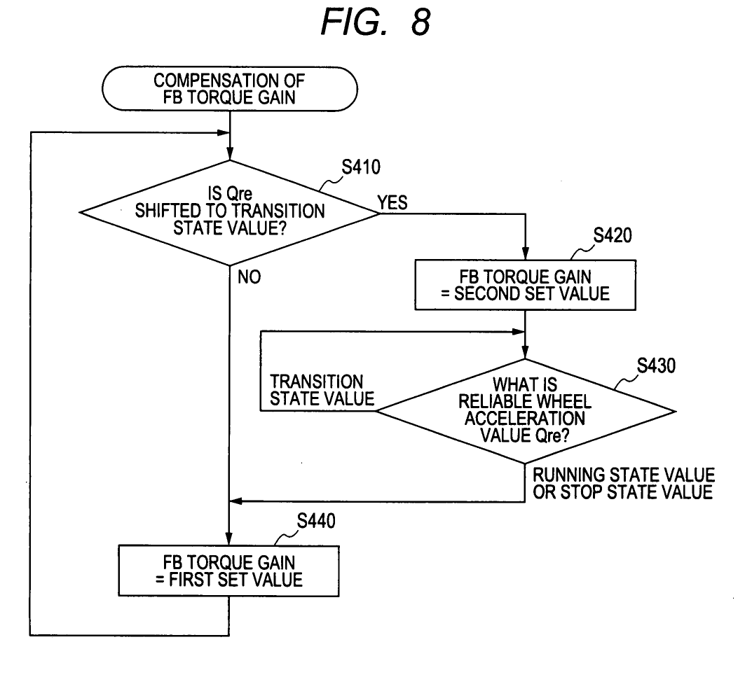

The FB torque gain compensation part 31 is realized for the cruise assist ECU 20 to perform the process of adjusting the FB torque gain shown in FIG. 8.

FIG. 8 is a flow chart showing the process of the FB torque gain compensation part 31 in the cruise assist ECU to adjust a FB torque gain.

As shown in FIG. 8, the FB torque gain compensation part 31 detects whether or not the reliable wheel acceleration value Qᵣₑ transferred from the wheel acceleration reliable calculation part 28 is changed to the transition-state value from the running-state value or the stop-state value (step S410).

When the judgment result in step S410 indicates that the reliable wheel acceleration value Qᵣₑ is changed to the transition-state value, the FB torque gain compensation part 31 sets a predetermined second set value to the FB torque gain (step S420).

When the reliable wheel acceleration value Qᵣₑ transferred from the wheel acceleration reliable calculation part 28 is the transition-state value, the operation waits until the timing when the reliable wheel acceleration value Qᵣₑ transferred from the wheel acceleration reliable calculation part 28 is changed from the transition-state value to the running-state value or the stop-state value (transition-state value, step S430).

When the driving state of the driver's vehicle is the drive state immediately before vehicle stop or the drive state immediately after vehicle start, the FB torque control part 30 maintains the FB torque gain with the second set value which is set at the timing when the reliable wheel acceleration value Qᵣₑ transferred from the wheel acceleration reliable calculation part 28 is changed to the transition-state value from the running-state value or the stop-state value.

When the reliable wheel acceleration value Qᵣₑ is changed from the transition-state value to the running-state value or the stop-state value (step S430), the operation flow progresses to step S440.

On the other hand, when the judgment result in step S410 indicates that the driving state of the reliable wheel acceleration value Qᵣₑ is the running state or the stop state, the operation flow goes to step S440. That is, when the reliable wheel acceleration value Qᵣₑ has the running-state value or the stop-state value, the operation flow goes to step S440.

In step S440, the FB torque gain compensation part 31 sets the first set value which is greater than the second set value to the FB torque gain (step S420). The operation flow then returns to step S410.

That is, the FB torque gain compensation part 31 maintains the FB torque gain of the first set value when the driving state of the driver's vehicle is in the running state or in the drive state immediately before vehicle stop.

The FB torque gain compensation part 31 changes the FB torque gain from the first set value to the second set value when the driving state of the driver's vehicle is shifted from the running state to the drive state immediately before vehicle stop or from the stop state to the drive state immediately after vehicle start. Further, the FB torque gain compensation part 31 maintains the FB torque gain with the second set value during the drive state immediately before vehicle stop or the drive state immediately after vehicle start.

Because the second set value is smaller than the first set value, a response delay in the feedback control performed by the FB torque control part 30 becomes large when the FB torque gain compensation part 31 changes the FB torque gain from the first set value to the second set value.

### <Effects of the Cruise Assist ECU 20 as the Acceleration Control Device According to the First Embodiment>

As previously described, in the cruise assist ECU 20 as the acceleration control device according to the first embodiment of the present invention, the FB torque gain is changed to a smaller value, that is, to the second set value when the driving state of the driver's vehicle is shifted to the transition state, as compared with the FB torque gain when the driving state of the driver's vehicle is the running state or the stop state.

The change value of the FB torque T_{offset}_{_{—}}_{fb} output from the FB torque control part 30 when the driving state of the driver's vehicle is the transition state becomes a small value even if the difference between the wheel acceleration a_{act} and the actual acceleration in the longitudinal direction of the driver's vehicle. In other words, according to the cruise assist ECU 20 according to the first embodiment of the present invention, the FB torque T_{offset}_{_{—}}_{fb} during the transition state is slowly changed to the elapse of time when compared with the FB torque T_{offset}_{_{—}}_{fb} during the running state or the stop state of the driver's vehicle.

That is, according to the cruise assist ECU 20 according to the first embodiment of the present invention, the FB control prevents the damping torque and the drive torque generated in the driver's vehicle from beng significantly changed even if the wheel acceleration a_{act} transferred from the brake ECU 16 is different from the actual acceleration in the longitudinal direction of the driver's vehicle.

By the way, when the driving state of the driver's vehicle is shifted from the running state to the transition state, the cruise assist ECU 20 in the cruise assist system 1 according to the first embodiment calculates, as the gradient acceleration a_{grad}, the value obtained by subtracting the wheel acceleration a_{act} received at the timing to change the driving state of the driver's vehicle from the total acceleration a_{g} received at the timing to change the driving state of the driver's vehicle. In addition, the cruise assist ECU 20 maintains the gradient acceleration a_{grad} which is calculated at the timing when the driving state of the driver's vehicle is changed during the transition state of the driver's vehicle.

That is, the drive state immediately before vehicle stop has a very short time period before the driver's vehicle stops. The drive state immediately after vehicle start is also a very short time period immediately after driver's vehicle starts. Therefore there is a low possibility for the gradient of the inclination of the road on which the driver's vehicle is running to be changed. The gradient acceleration a_{grad} at the timing when the driving state of the driver's vehicle becomes the transition state can be approximately equal to the actual gradient acceleration which is given to the driver's vehicle.

It is not necessary for the cruise assist ECU 20 to calculate the gradient acceleration a_{grad} which is significantly different from the actual gradient acceleration of the driver's vehicle, and thereby to calculate the gradient resistance compensation torque T_{grad} more than required or less than required.

According to the cruise assist ECU 20 of the first embodiment, even if the wheel acceleration a_{act} transferred from the brake ECU 16 of the driver's vehicle is different from the actual acceleration in the longitudinal direction of the driver's vehicle, the FB control prevents the damping torque and the drive torque generated in the driver's vehicle from becoming greatly changed.

As a result, according to the vehicle with the cruise assist system 1 equipped with the cruise assist ECU 20 as the acceleration control device according to the first embodiment, it is possible to avoid sudden stop and sudden start of the driver's vehicle and to increase comfortable drive of the passengers and driver of the vehicle during the transition state of the driver's vehicle.

In particular, the cruise assist ECU 20 according to the first embodiment of the present invention decreases the FB control gain and changes the method to calculate the gradient acceleration at the timing when the driving state of the driver's vehicle is changed from the running state to the drive state immediately before vehicle stop or changed from the stop state to the drive state immediately after vehicle start.

Accordingly, the cruise assist ECU 20 according to the first embodiment of the present invention can improve comfortable drive of the passengers and driver of the vehicle in the drive state immediately before vehicle stop and the drive state immediately after vehicle start.

### Second Embodiment

A description will be given of the cruise assist system equipped with cruise assist ECU 20 according to a second embodiment of the present invention.

The cruise assist system has an acceleration control device which is different in configuration and operation from the acceleration control device according to the first embodiment, previously described. Other components of the cruise assist ECU 20 according to the second embodiment are the same as those of the first embodiment. The same components are referred to with the same reference numbers and the explanation thereof is omitted here for brevity.

### <Cruise Assist ECU 20>

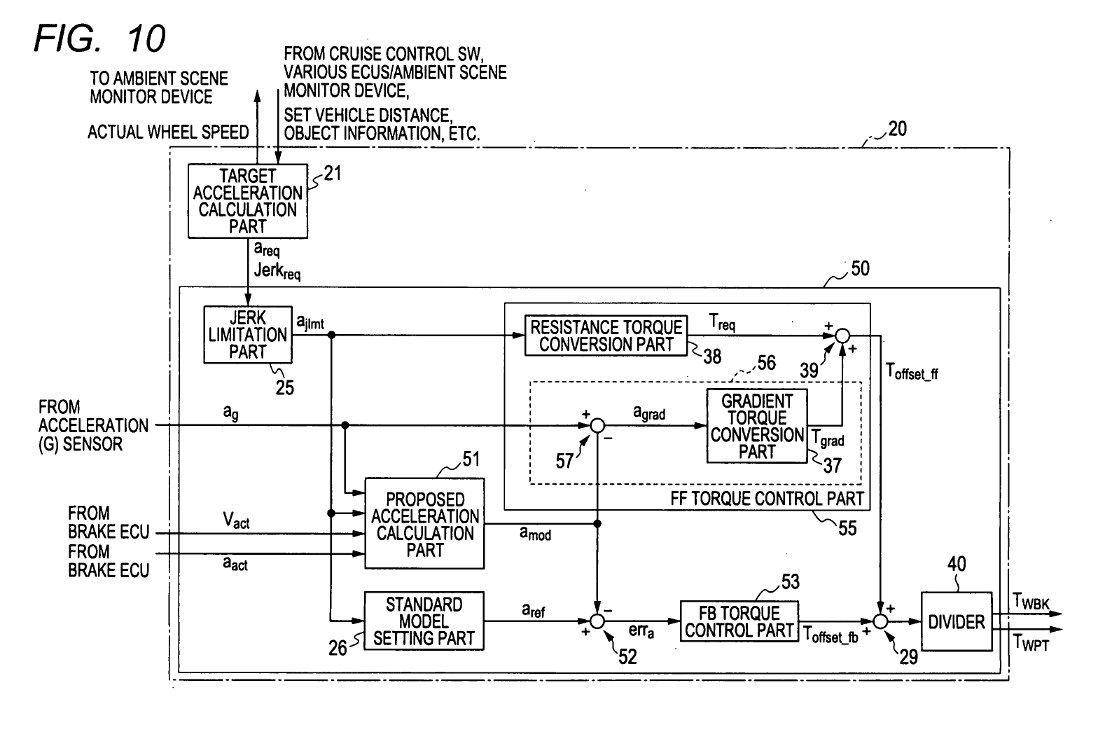

FIG. 10 is a block diagram showing a schematic configuration of the cruise assist system equipped with the cruise assist ECU 20 according to the second embodiment of the present invention.

The cruise assist ECU 20 according to the second embodiment serves as a target acceleration calculator 21 to repeatedly calculate the target acceleration a_{req} and the request jerk limitation value Jerk_{req} every predetermined timing. In addition, the cruise assist ECU 20 also serves as the acceleration controller 50 to calculate the power train request torque T_{wPT} and the brake request torque T_{wBK} according to the target acceleration a_{req}.

### <Acceleration Controller>

The acceleration controller 50 has a jerk control part 25 and a standard model setting part 26 having s standard model. The jerk control part 25 calculates a requested acceleration aⱼₗₘₜ after jerk limitation. When the standard model composed of a primary delay model in the standard model setting part 26 receives the requested acceleration aⱼₗₘₜ after jerk limitation, the standard model setting part 26 generates a standard response acceleration a_{ref}.

The acceleration controller 50 has a proposed acceleration calculation part 51 and a FF torque control part 55.

The proposed acceleration calculation part 51 estimates an acceleration (which corresponds to the acceleration in the longitudinal direction, hereinafter will be referred to as the “proposed acceleration a_{mod}”) to be given in the longitudinal direction of the driver's vehicle according to the driving state of the driver's vehicle which is detected based on various information which are supplied to the cruise assist ECU 20. The FF torque control part 55 calculates a FF control value.

The acceleration controller 50 has an acceleration deviation calculation part 52 and a FB torque control part 53.

The acceleration deviation calculation part 52 calculates a deviation (that is, referred to as the “acceleration error err_{—}_{^{a}}”) between the standard response acceleration a_{ref} transferred from the standard model setting part 26 and the proposed acceleration a_{mod} transferred from the proposed acceleration calculation part 51.

The FB torque control part 53 calculates the FB torque T_{offset}_{_{—}}_{fb} which is supplied to the power train mechanism 5 and the brake mechanism 10 based on the acceleration error err_{—}_{^{a}} calculated by the acceleration deviation calculation part 52.

In addition, the acceleration controller 50 has the control torque calculation part 29 and the divider 40. The control torque calculation part 29 calculates a sum (hereinafter, referred to as the “control torque Tw”) of the FB torque T_{offset}_{_{—}}_{fd} calculated by the FB torque control part 53 and the FF control value (T_{offset}_{_{—}}_{ff} shown in FIG. 10) calculated by the FF torque control part 55.

The divider 40 divides the control torque Tw calculated by the control torque calculation part 29 into the request power train torque T_{wPT} and the request brake torque T_{wBK} according to a predetermined condition.

### <FF Torque Control Part 55>

A description will now be given of the FF torque control part 55 in the cruise assist ECU 20 according to the second embodiment of the present invention shown in FIG. 10.

The FF torque control part 55 has the resistance torque conversion part 38, a gradient torque calculation part 56, and the FF torque calculation part 39.

The resistance torque conversion part 38 calculates an air resistance compensation torque, and a rolling resistance compensation torque.

The gradient torque calculation part 56 calculates a gradient resistance compensation torque T_{grad}”.

The FF torque calculation part 39 calculates a FF torque T_{offset#fb} by adding the air resistance compensation torque calculated by the resistance torque conversion part 38, the rolling resistance compensation torque, and the gradient resistance compensation torque T_{grad} calculated by the gradient torque calculation part 56.

The gradient torque calculation part 56 has a gradient acceleration calculation part 57 and the gradient resistance torque conversion part 37.

The gradient acceleration calculation part 57 calculates the gradient acceleration a_{grad}. The gradient resistance torque conversion part 37 calculates the gradient resistance compensation torque T_{grad} based on the gradient acceleration a_{grad} calculated by the gradient acceleration calculation part 57 by using the equation (3), previously described.

The gradient acceleration calculation part 57 calculates, as the gradient acceleration a_{grad}, the value obtained by subtracting the proposed acceleration a_{mod}, every transferred from the proposed acceleration calculation part 51, from the total acceleration a_{g}, every transferred from the acceleration sensor 14.

### <FB Torque Control Part>

A description will now be given of the FB torque control part 53 in the cruise assist ECU 20 according to the second embodiment of the present invention.

The FB torque control part 53 calculates a FB torque T_{offset}_{_{—}}_{fb} by providing an acceleration error err_{—}_{^{a}} to a PID control model. The acceleration error err_{—}_{^{a}} is calculated by the acceleration deviation calculation part 52.

This PID control model calculates a proportional component (P), a integration component (I), and a differential component (D) based on the acceleration error err_{—}_{^{a}}, and outputs the FB torque T_{offset}_{_{—}}_{fb} which is the sum of:

a value obtained by multiplying the proportional component (P) with a control gain;

a value obtained by multiplying the integration component (I) with the control gain; and

a value obtained by multiplying the differential component (D) with the control gain.

The above control gain will be referred to as the “FB torque gain”.

### <Proposed Acceleration Calculation Part>

A description will now be given of the proposed acceleration calculation part 51 in the cruise assist ECU 20 according to the second embodiment of the present invention.

The proposed acceleration calculation part 51 has a drive state detection function to detect the driving state of the driver's vehicle based on the wheel speed V_{act} transferred from the brake ECU 16 and the requested acceleration aⱼₗₘₜ after jerk limitation transferred from the jerk limitation part 25.

In addition, the proposed acceleration calculation part 51 has a proposed acceleration calculation function to calculate the proposed acceleration a_{mod} based on the wheel acceleration a_{act} transferred from the brake ECU 16 and the total acceleration a_{g} transferred from the acceleration sensor 14.

The proposed acceleration calculation part 51 having the drive state detection function and the proposed acceleration calculation function is realized by performing various processes performed by the cruise assist ECU 20 according to the driving state of the driver's vehicle.

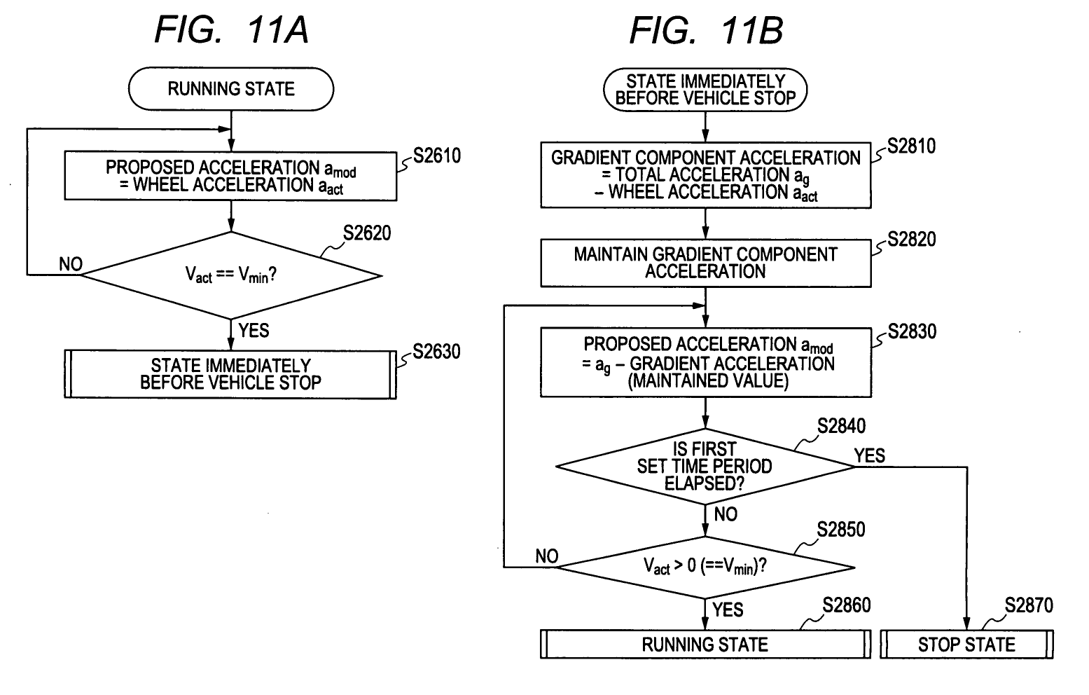

FIG. 11A is a flow chart showing the process of the cruise assist ECU 20 according to the second embodiment to calculate a proposed value of the wheel acceleration in the driving state of the vehicle. FIG. 11B is a flow chart showing the process of the cruise assist ECU 20 according to the second embodiment to calculate the proposed value of the wheel acceleration in the drive state immediately before vehicle stop;

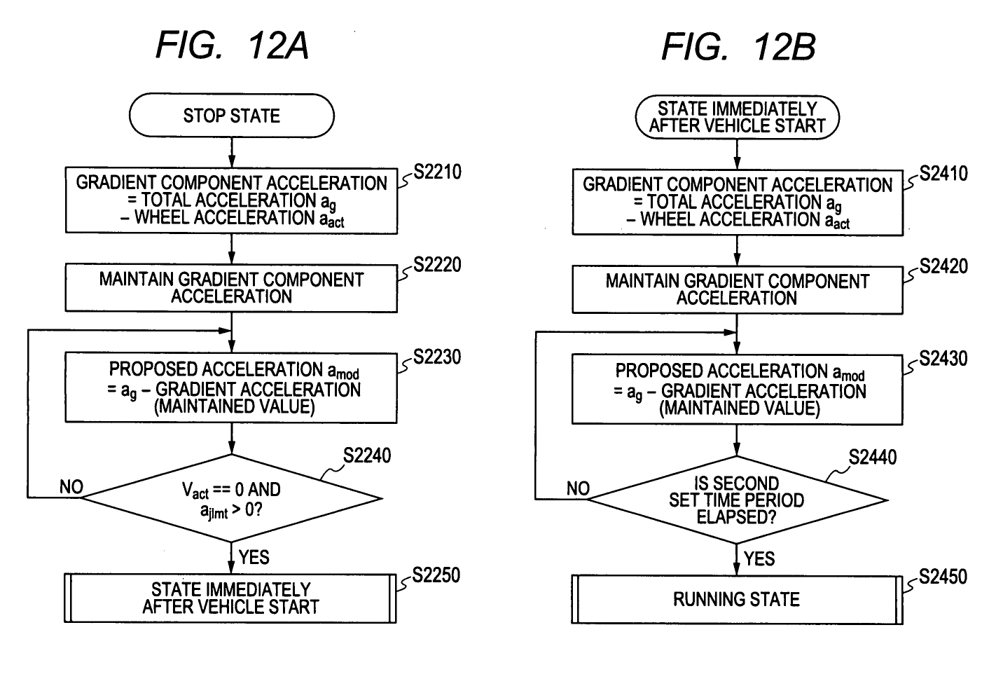

In addition, FIG. 12A is a flow chart showing the process of the cruise assist ECU 20 according to the second embodiment to calculate the proposed value of the wheel acceleration when the vehicle stops. FIG. 12B is a flow chart showing the process of the cruise assist ECU 20 according to the second embodiment to calculate the proposed value of the wheel acceleration in the drive state immediately after vehicle start.

Specifically, when receiving the set-on signal, the cruise assist ECU 20 detects that the driving state of the driver's vehicle is the stop state when the wheel speed V_{act} is not more than 0 km/h (see FIG. 4).

When the driving state of the driver's vehicle enters the stop state, the cruise assist ECU 20 initiates the stop-state process shown in FIG. 12A.

When starting the stop-state process shown in FIG. 12A (hereinafter, referred to as the “timing to change the driving state during vehicle stop”), the proposed acceleration calculation part 51 subtracts the wheel acceleration a_{act} transferred from the brake ECU 16 from the total acceleration a_{g} transferred from the acceleration sensor 14 at the timing to change the drive state during vehicle stop (step S2210).

The calculated value at step S2210 becomes the acceleration of gravity to be given to the driver's vehicle by the inclination of the road when the driver's vehicle is on the road with an inclination. When the driver's vehicle is on a flat road, the calculated value obtained at step S2210 becomes 0 m/s².

The proposed acceleration calculation part 51 stores the gradient component acceleration calculated in step S2210 (S2220), and calculates a value by subtracting the stored gradient component acceleration from the total acceleration a_{g} transferred from the acceleration sensor 14, and outputs the calculation result as the proposed acceleration a_{mod} (step S2230).

When the wheel speed V_{act} is 0 km/h, and the requested acceleration aⱼₗₘₜ after jerk limitation transferred from the jerk limitation part 25 is equal to 0 m/s² (“NO” in step S2240), the cruise assist ECU 20 judges that the driver's vehicle continues to stop, the operation flow returns to step S2230.

During the period where the driver's vehicle stops, the proposed acceleration calculation part 51 repeatedly outputs, as the proposed acceleration a_{mod}, the value which is obtained by subtracting the gradient component acceleration, which is calculated at the timing to change the driving state during vehicle stop, from the total acceleration a_{g}, every transferred from the acceleration sensor 14.

On the other hand, when the wheel speed V_{act} is 0 km/h, and the requested acceleration aⱼₗₘₜ after jerk limitation transferred from the jerk limitation part 25 is more than 0m/s² (“YES” in step S2240), the cruise assist ECU 20 judges that the driving state of the driver's vehicle is changed from to the drive state immediately after vehicle start, and initiates the process immediately after vehicle start (step S2250) stop, the operation flow returns to step S2230.

When the driving state of the driver's vehicle becomes the drive state immediately after vehicle start, and the cruise assist ECU 20 initiates the process immediately after vehicle start, as shown in FIG. 12B, the proposed acceleration calculation part 51 calculates the gradient component acceleration by subtracting the wheel acceleration a_{act} transferred from the brake ECU 16 at the timing immediately after vehicle start from the total acceleration a_{g} transferred from the acceleration sensor 14 at the timing when the driving state of the driver's vehicle is changed to the timing immediately after vehicle start (hereinafter, referred to as the “timing immediately after vehicle start”) (step S2410).

In step S2420, the cruise assist ECU 20 stores the gradient component acceleration calculated in step S2410, outputs, as the proposed acceleration a_{mod}, the value obtained by subtracting the stored gradient component acceleration from the total acceleration a_{g} transferred from the acceleration sensor 14 (step S2430).

When the current time counted from the timing when the driving state of the driver's vehicle is shifted to the drive state immediately after vehicle start is less than the second set time period (“NO” in step S2440), the cruise assist ECU 20 judges that the driver's vehicle continues to maintain the running state, and the operation flow returns to step S2430.

This makes it possible for the proposed acceleration calculation part 51 to output, as the proposed acceleration a_{mod}, the value obtained by subtracting the gradient component acceleration calculated at the timing immediately after vehicle start from the total acceleration a_{g}, every transferred from the acceleration sensor 14, during the running state of the driver's vehicle.

On the other hand, the second set time period is elapsed after the driving state of the driver's vehicle is changed to the drive state immediately after vehicle start (“YES” in step S2440), the cruise assist ECU 20 initiates the process during the running state (step S2450) because the cruise assist ECU 20 judges that the driving state of the driver's vehicle is changed to the running state.

When the driving state of the driver's vehicle is changed to the running state, and the cruise assist ECU 20 starts the process during the running state, as shown in FIG. 11A, the proposed acceleration calculation part 51 outputs the wheel acceleration a_{act} transferred from the brake ECU 16 as the proposed acceleration a_{mod} (step S2610).

When the wheel speed V_{act} transferred from the brake ECU 16 is not equal to the minimum detection speed Vₘᵢₙ (“NO” in step S2620), the operation flow returns to step S2610 until the wheel speed V_{act} becomes equal to the minimum detection speed Vₘᵢₙ because the cruise assist ECU 20 judges that the driver's vehicle continues to maintain the running state.

This makes it possible to output the wheel acceleration a_{act}, every transferred from the brake ECU 16 as the proposed acceleration a_{mod}.

On the other hand, when the wheel speed V_{act} transferred from the brake ECU 16 becomes equal to the minimum detection speed Vₘᵢₙ (“YES” in step S2620), the cruise assist ECU 20 starts the process immediately before vehicle stop because the cruise assist ECU 20 judges that the driving state of the gradient component acceleration is shifted to the drive state immediately before vehicle start (step S2630).

When the driving state of the driver's vehicle becomes the drive state immediately before vehicle stop, and the cruise assist ECU 20 starts the process immediately before vehicle stop, as shown in FIG. 11B, the proposed acceleration calculation part 51 calculates the gradient component acceleration by subtracting the wheel acceleration a_{act} transferred from the brake ECU 16 at the timing immediately before vehicle stop from the total acceleration a_{g} transferred from the acceleration sensor 14 at the timing when the driving state of the driver's vehicle is changed to the timing immediately before vehicle stop (step S2810).

In step S2820, the cruise assist ECU 20 stores the gradient component acceleration calculated in step S2810, outputs, as the proposed acceleration a_{mod}, the value obtained by subtracting the stored gradient component acceleration from the total acceleration a_{g} transferred from the acceleration sensor 14 (step S2830).

When the current time counted from the timing when the driving state of the driver's vehicle is shifted to the drive state immediately before vehicle stop is less than the first set time period (“NO” in step S2840), and the wheel speed V_{act} transferred from the brake ECU 16 is not less than the minimum detection speed Vₘᵢₙ at this time (“NO” in step S2850), the cruise assist ECU 20 judges that the driver's vehicle continues to maintain the drive state immediately before vehicle stop, and the operation flow returns to step S2830. This makes it possible for the proposed acceleration calculation part 51 to output, as the proposed acceleration a_{mod}, the value obtained by subtracting the stored gradient component acceleration from the total acceleration a_{g}, every transferred from the acceleration sensor 14 while the driver's vehicle is in the drive state immediately before vehicle stop.

When the first set time period is elapsed after the driving state of the driver's vehicle is changed to the drive state immediately before vehicle start (“YES” in step S2840), the cruise assist ECU 20 initiates the process during the stop state (step S2870) because the cruise assist ECU 20 judges that the driving state of the driver's vehicle is shifted to the stop state.

In addition, when the wheel speed V_{act} transferred from the brake ECU 16 is more than the minimum detection speed Vₘᵢₙ (“YES” in step S2850) before the elapse of the first set time period counted form the transition of the driving state of the driver's vehicle to the drive state immediately before vehicle stop (“NO” in step S2840).

Specifically, when receiving the set-on signal, the cruise assist ECU 20 detects that the driving state of the driver's vehicle is the running state when the wheel speed V_{act} is more than 0 km/h.

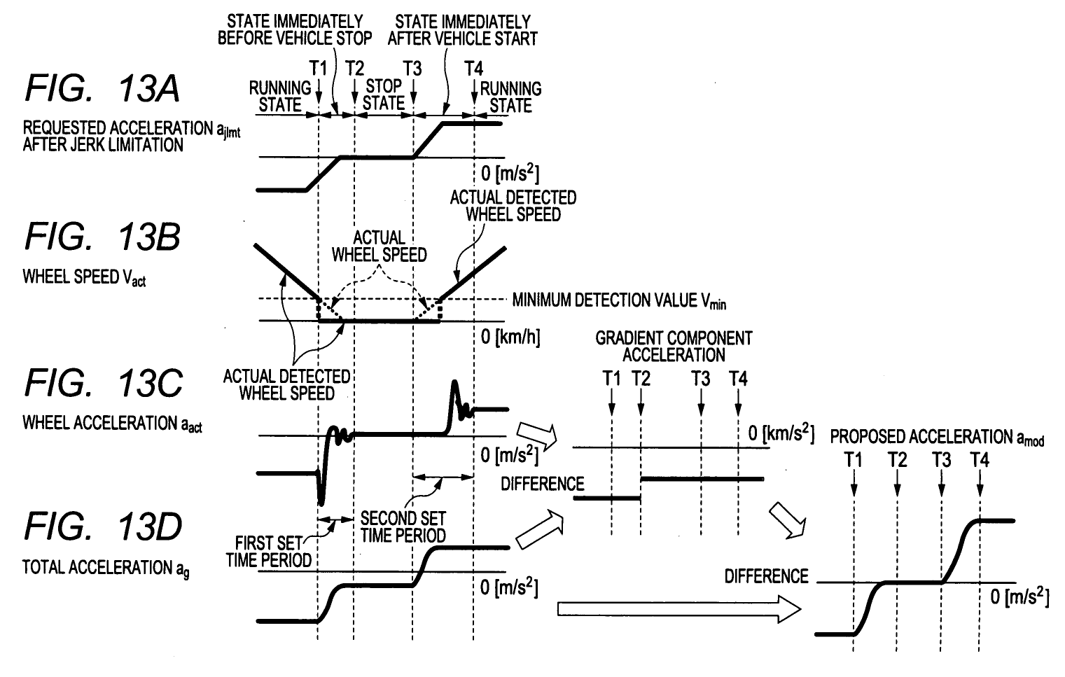

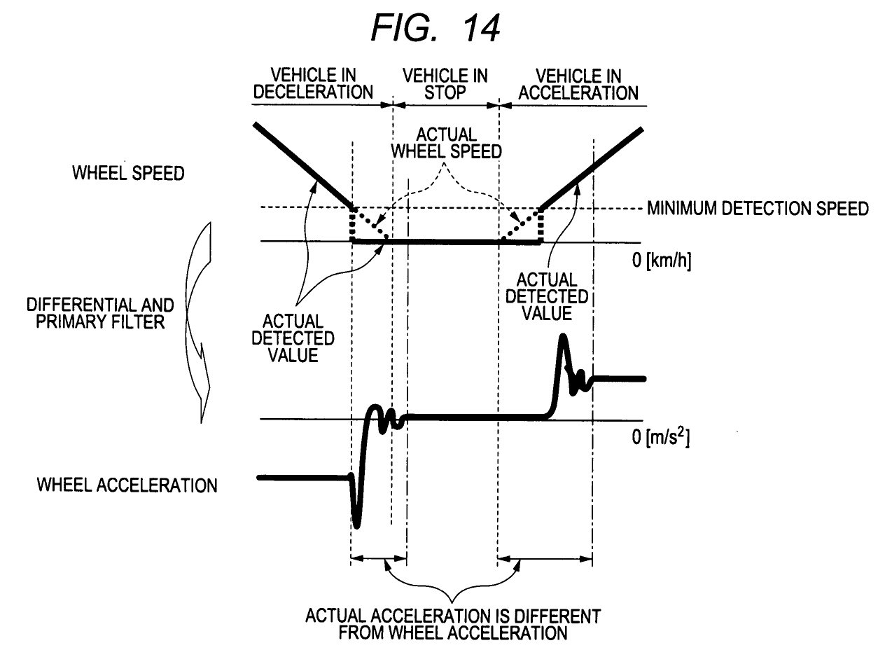

FIG. 13A to FIG. 13D show the relationships between the requested acceleration after jerk limitation, the wheel speed V_{act}, the wheel acceleration a_{act}, the total acceleration a_{g}, the gradient component acceleration, and the proposed acceleration a_{mod}, and an elapse of time which are changed according to the driving state after vehicle stop after the driver's vehicle is decelerated, and the acceleration state of the driver's vehicle after vehicle start.

That is, when the driver's vehicle is decelerated and then stops, as shown in FIG. 13A to FIG. 13D, the wheel speed V_{act} of the driver's on vehicle becomes equal to the minimum detection speed Vₘᵢₙ after the wheel speed V_{act} of the driver's vehicle is not less than the minimum detection speed Vₘᵢₙ (that is, from the running state of the driver's vehicle).

At this time, because the driving state of the driver's vehicle is shifted from the running state to the drive state immediately before vehicle stop, the cruise assist ECU 20 according to the second embodiment maintains the calculated gradient component acceleration when the timing T1 (see FIG. 13C) which is immediately before the driver's vehicle stops.

The gradient component acceleration calculated at this timing is maintained until the first set time period is elapsed after the wheel speed V_{act} becomes equal to the minimum detection speed Vₘᵢₙ, that is, during the period where the driver's vehicle is in the drive state immediately before vehicle stop (during the period between the timing T1 and the timing T2 shown in FIG. 13C).

While the driver's vehicle is in the drive state immediately before vehicle stop, the proposed acceleration calculation part 51 outputs, as the proposed acceleration a_{mod}, the value obtained by subtracting the total acceleration a_{g}, every transferred from the acceleration sensor 14 from the gradient component acceleration which is calculated at the timing in drive state immediately before vehicle stop, and the proposed acceleration calculation part 51 maintains the output, that is, the proposed acceleration a_{mod}.

Because the driving state of the driver's vehicle is shifted from the running state to the drive state immediately before vehicle stop when the first set time period counted from the timing (T2 shown in FIG. 13B) when the wheel speed V_{act} becomes equal to the minimum detection speed Vₘᵢₙ, the cruise assist ECU 20 according to the second embodiment maintains the gradient component acceleration which is calculated at the timing T2 (see FIG. 13C) when the driving state of the driver's vehicle is shifted to the drive state immediately before vehicle stop.

The calculated gradient component acceleration calculated at the timing T2 (see FIG. 13C) has the vehicle speed V_{act} of 0 km/h, and maintains this vehicle speed V_{act} until the timing when the requested acceleration aⱼₗₘₜ after jerk limitation becomes more than 0 m/s² (the time period between T2 and T3 shown in FIG. 13C).

While the driver's vehicle is in the stop state, the proposed acceleration calculation part 51 outputs, as the proposed acceleration a_{mod}, the value obtained by subtracting the gradient component acceleration calculated and maintained at the time when the driver's vehicle is shifted to the vehicle stop from the total acceleration a_{g}, every transferred from the acceleration sensor 14.

At the timing T3 shown in FIG. 13A to FIG. 13D, the requested acceleration aⱼₗₘₜ after jerk limitation becomes more than 0 m/s².

At this time, because the driving state of the driver's vehicle is shifted to the drive state immediately after vehicle start from the stop state, the cruise assist ECU 20 according to the second embodiment maintains the gradient component acceleration which is calculated at the timing T3 (see FIG. 13C) when the driving state of the driver's vehicle is shifted to the drive state immediately after vehicle start. This gradient component acceleration calculated at this timing is maintained during the time period from the timing to shift the driving state of the driver's vehicle to the drive state immediately after vehicle start to the timing when the second set time period is elapsed, that is, while the driver's vehicle is in the drive state immediately after vehicle start (T3 to T4 shown in FIG. 13c).

While the driver's vehicle is in the drive state immediately after vehicle start, the proposed acceleration calculation part 51 outputs, as the proposed acceleration a_{mod}, the value obtained by subtracting the total acceleration a_{g}, every transferred from the acceleration sensor 14, from the gradient component acceleration which is calculated at the timing of the drive state immediately after vehicle start and maintained.

When the second set time period is elapsed after the driving state of the driver's vehicle is shifted to the drive state immediately after vehicle start (T4 shown in FIG. 13A to FIG. 13D), the driving state of the driver's vehicle is shifted to the running state. The cruise assist ECU 20 according to the second embodiment outputs, as the proposed acceleration a_{mod}, the wheel acceleration a_{act}, every transferred from the brake ECU 16 during the running state of the driver's vehicle.

### <Effects of the Cruise Assist ECU 20 According to the Second Embodiment>

The drive state immediately before vehicle stop is a very short time period before the driver's vehicle stops. The drive state immediately after vehicle start is also a very short time period after the driver's vehicle starts. Therefore there is a low possibility for the inclination of the road on which the driver's vehicle is running to decrease during the above very short time period.

It is therefore possible for the proposed acceleration a_{mod} to be approximately equal to the actual acceleration in the longitudinal direction of the driver's vehicle, where this proposed acceleration a_{mod} is calculated by subtracting the gradient component acceleration, which is calculated at the shift timing previously described and then maintained, from the total acceleration a_{g}, every transferred from the acceleration sensor 14.

In other words, the cruise assist ECU 20 according to the second embodiment can avoid that the proposed acceleration a_{mod} is different from the actual acceleration in the longitudinal direction of the driver's vehicle.

The cruise assist ECU 20 according to the second embodiment can prevent the generation of the drive torque or the damping torque which is significantly different from the required value (i.e. more than required or less than required) because it is not necessary to perform the FB control by using the proposed acceleration a_{mod} which is different from the actual acceleration in the longitudinal direction of the driver's vehicle.

The cruise assist ECU 20 according to the second embodiment calculates the gradient acceleration a_{grad} by using the calculated proposed acceleration a_{mod} and then calculates the gradient resistance compensation torque T_{grad}. This makes it possible for the cruise assist ECU 20 according to the second embodiment to avoid calculating the gradient resistance compensation torque T_{grad} more than required (or less than required) by the FF control.

It is possible for the cruise assist ECU 20 according to the second embodiment to prevent the brake torque and the damping torque more than required or less than required from being generated in the driver's vehicle by the FF control even if the driving state of the driver's vehicle is different from the actual acceleration in the longitudinal direction of the driver's vehicle.

Accordingly, as previously described in detail, the vehicle equipped with the cruise assist ECU 20 according to the second embodiment can improve comfortable driving for the passengers and driver of the vehicle during the transition state to shift the stop state or the running state of the driver's vehicle.

In particular, the cruise assist ECU 20 according to the second embodiment changes the method to calculate the proposed acceleration a_{mod} at the timing when the driving state of the driver's vehicle is shifted from the running state to the drive state immediately before vehicle stop or from the stop state to the drive state immediately after vehicle start.

According to the cruise assist ECU 20 according to the second embodiment of the present invention, it is possible to improve comfortable drive for the passengers and driver of the vehicle when the drive state immediately before vehicle stop or when the drive state immediately after vehicle start.

### <Other Modifications>

The concept of the present invention is not limited by the first and second embodiments previously described. For example, it is possible to modify the cruise assist ECU 20 according to the first and second embodiments within the scope of the present invention.

For example, in the cruise assist system equipped with the cruise assist ECU 20 according to the first and second embodiments, the brake assist ECU 16 calculates the wheel speed V_{act} and the wheel acceleration a_{act} based on detection signal transferred from the wheel speed sensors 13. The present invention is not limited by this. It is also possible for the cruise assist ECU 20 to calculate the wheel speed V_{act} and the wheel acceleration a_{act} based on detection signal transferred from the wheel speed sensors 13. That is, the cruise assist ECU 20, which serves as the acceleration control device, can calculate the wheel speed V_{act} and the wheel acceleration a_{act} when having the mechanism to receive detection signals transferred from the wheel speed sensors 13.

Further, in the FF torque control part 55 in the cruise assist ECU 20 according to the second embodiment, the gradient acceleration calculation part 57 calculates the gradient acceleration a_{grad} which is converted to the gradient resistance compensation torque T_{grad} by the gradient resistance torque conversion part 37. However, the present invention is not limited by this. For example, it is possible to use, as the gradient acceleration a_{grad}, the gradient component acceleration calculated by the proposed acceleration calculation part 51. That is, it is possible to eliminate the gradient acceleration calculation part 57 from the configuration of the FF torque control part 55.

It is also possible to use any value (for example, zero) which is smaller than the first set value as the second set value which is set by the FB torque control part 30 in the configuration of the cruise assist ECU 20 according to the first embodiment. In this modification, the execution of the FB control is interrupted and the FF control is executed when the driving state of the driver's vehicle is shifted to the transition state. In this case, because the drive torque or the damping torque has a value based on the target acceleration a_{req}, there is no affect to change those drive toque or the damping torque even if the wheel acceleration a_{act} is different from the actual acceleration in the longitudinal direction of the driver's vehicle.

In the first and second embodiments previously described, the cruise assist ECU 20 executes application programs to realize the acceleration controllers 22 and 50. The present invention is not limited by this. For example, it is possible to use a combination of actual electric circuits (hardware) to realize the acceleration controllers 22 and 50.

It is also possible to use another electric circuit to realize the acceleration controllers 22 and 50 in addition to the hardware of the cruise assist ECU 20.

In the first and second embodiments previously described, the ambient scene monitor device 15 is composed of milliwave radar of FMCW type. The present invention is not limited by this. For example, it is possible to use on-vehicle cameras, a laser radar device, or a combination of such milliwave radar, on-vehicle cameras, and laser radar device. The on-vehicle cameras are placed at a front side of the driver's vehicle to photograph a forward image of the driver's vehicle in order to get object information based on photographed image. The laser radar device detects objects such as a front running vehicle and gets object information of the front running vehicle by receiving a reflected laser wave which is reflected by the front object such as a front vehicle.

The target acceleration calculator 21 corresponds to the target acceleration calculation means. The cruise assist ECU 20 has the function to receive the wheel speed transferred from the brake ECU 16, and this function of the cruise assist ECU 20 corresponds to the wheel speed obtaining means.

The cruise assist ECU 20 has the function to receive the wheel acceleration transferred from the brake ECU 16, and this function of the cruise assist ECU 20 corresponds to the wheel acceleration obtaining means.

The cruise assist ECU 20 has the function to receive the total acceleration transferred from the acceleration sensor 14, and this function of the cruise assist ECU 20 corresponds to the total acceleration obtaining means.

The FB torque control part 30, 53 has the function to perform the FB control, and this function of the FB torque control part 30, 53 corresponds to the feedback control part. The FF torque control part 33, 55 has the function to perform the FF control, and this function of the FF torque control part 33, 55 corresponds to the control acceleration calculation means and drive control means.

The proposed acceleration calculation part 51 has the function to detect the driving state of the driver's vehicle, and this function of the proposed acceleration calculation part 51 corresponds to the drive state detection means. The FB torque gain compensation part 31 corresponds to the control value compensation means.

The gradient acceleration calculation part 36 corresponds to the gradient acceleration calculation means, and the gradient acceleration storing means. The proposed acceleration calculation part 51 has the function to calculate the proposed acceleration, and this function of the proposed acceleration calculation part 51 corresponds to the acceleration calculation means.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. An acceleration control device, comprising:
target acceleration calculation means that calculates a target acceleration in order to control a driving state of a driver's vehicle to a target drive state;
wheel speed obtaining means that obtains a wheel speed of the driver's vehicle which is calculated based on a detection signal detected by and transferred from a wheel speed sensor, the detection signal being changed in pulse form depending on the rotation of wheel of the driver's vehicle;
wheel acceleration obtaining means that obtains a wheel acceleration of the driver's vehicle which is calculated based on a change of the wheel speed during a predetermined interval of time;
feedback control means that performs a feedback control of a brake torque or a damping torque generated in the driver's vehicle so that the wheel acceleration obtained by the wheel acceleration obtaining means is equal to the target acceleration calculated by the target acceleration calculation means;
drive state detection means that detects the driving state of the driver's vehicle, the drive state including at least a time in which the driver's vehicle will enter a transition state based on at least the wheel speed obtained by the wheel speed obtaining means, where an acceleration actually given to the driver's vehicle along a longitudinal direction of the driver's vehicle is an actual acceleration in the longitudinal direction of the driver's vehicle, and the transition state is a state with a possibility that the wheel acceleration obtained by the wheel acceleration obtaining means is different from the actual acceleration in the longitudinal direction of the driver's vehicle by a predetermined value; and
control value compensation means that performs a compensation control to compensate the control value of the feedback control in order to increase a response delay of the feedback control performed by the feedback control means when the detection result of the drive state detection means indicates that the driving state of the driver's vehicle will enter the transition state.

2. The acceleration control device according to claim 1, wherein the control value compensation means performs the compensation control during a period of the transition state of the driver's vehicle, where the period of the transition state is a time period when the driving state of the driver's vehicle is in the transition state.

3. The acceleration control device according to claim 2, wherein the control value compensation means determines, as the period of the transition state of the river's own vehicle, a period counted from the timing when the driving state of the driver's vehicle enters the transition state to a timing when a predetermined period of time is elapsed.

4. The acceleration control device according to claim 1, wherein the control value compensation means performs the compensation control to decrease a control gain used in the feedback control.

5. The acceleration control device according to claim 4, wherein the control value compensation means performs the compensation control using the control gain of zero.

6. The acceleration control device according to claim 1, further comprising:
total acceleration obtaining means that obtains a total acceleration of the driver's vehicle which expresses a total acceleration including an acceleration of gravity given to the driver's vehicle detected by an acceleration sensor, the acceleration of gravity being given to the driver's vehicle;
gradient acceleration calculation means that calculates a gradient acceleration by subtracting the wheel acceleration obtained by the wheel acceleration obtaining means from the total acceleration obtained by the total acceleration obtaining means, and outputs the gradient acceleration;
control acceleration calculation means that calculate a control acceleration which is obtained by adding the gradient acceleration obtained by the gradient acceleration calculation means to the target acceleration calculated by the target acceleration calculation means;
drive control means that performs a drive control to generate the control acceleration in the driver's vehicle according to the control acceleration calculated by the control acceleration calculation means; and
gradient acceleration maintaining means that performs an acceleration maintain control to maintain, as the output value during the period of the transition state, the gradient acceleration calculated at the time when the driver's vehicle is shifted to the transition state by the gradient acceleration calculation means when the detection result of the drive state detection means indicates that the driving state of the driver's vehicle has shifted to the transition state.

7. An acceleration control device, comprising:
wheel speed obtaining means that obtains a wheel speed of a driver's vehicle which is calculated based on a detection signal transferred from a wheel speed sensor, the detection signal being changed in pulse form depending on the rotation of wheel of the driver's vehicle;
wheel acceleration obtaining means that obtains a wheel acceleration of the driver's vehicle which is calculated based on a change of the wheel speed during a predetermined interval of time;
total acceleration obtaining means that obtains a total acceleration of the driver's vehicle which expresses a total acceleration including an acceleration of gravity given to the driver's vehicle, the acceleration of gravity being given to the driver's vehicle;
gradient acceleration calculation means that calculates a gradient acceleration by subtracting the wheel acceleration obtained by the wheel acceleration obtaining means from the total acceleration obtained by the total acceleration obtaining means, and outputs the gradient acceleration;
control acceleration calculation means that calculate a target acceleration in order to control a driving state of the driver's vehicle to a target drive state based on the calculated target acceleration, and calculates a control acceleration which is obtained by adding, to the target acceleration, at least the gradient acceleration obtained by the gradient acceleration calculation means;
drive control means that performs a drive control to generate the control acceleration in the driver's vehicle according to the control acceleration calculated by the control acceleration calculation means;
drive state detection means that detects the driving state of the driver's vehicle, the drive state including at least a timing to shift the driving state of the driver's vehicle to a transition state based on at least the wheel speed obtained by the wheel speed obtaining means, where an acceleration actually given to the driver's vehicle along a longitudinal direction of the driver's vehicle is an actual acceleration in the longitudinal direction of the driver's vehicle, and the transition state is a state with a possibility that the wheel acceleration obtained by the wheel acceleration obtaining means is different from the actual acceleration in the longitudinal direction of the driver's vehicle by a predetermined value; and
gradient acceleration maintaining means that maintains, as the output value during the period of the transition state, the gradient acceleration calculated at the time of entering the transition state by the gradient acceleration calculation means when the detection result of the drive state detection means indicates that the driving state of the driver's vehicle is shifted to the transition state.

8. The acceleration control device according to claim 6, wherein the gradient acceleration maintaining means determines, as the period of the transition state, a period counted from a timing when the driving state of the driver's vehicle becomes the transition state to a timing when a predetermined time length is elapsed.

9. An acceleration control device, comprising:
target acceleration calculation means that calculates a target acceleration in order to control a driving state of a driver's vehicle to a target drive state based on the calculated target acceleration;
feedback control means that performs a feedback control of a brake torque or a damping torque generated in the driver's vehicle so that an acceleration in a longitudinal direction given to the driver's vehicle is equal to the target acceleration calculated by the target acceleration calculation means;
wheel speed obtaining means that obtains a wheel speed of the driver's vehicle which is calculated based on a detection signal detected by and transferred from a wheel speed sensor, the detection signal being changed in pulse form depending on the rotation of wheel of the driver's vehicle;
wheel acceleration obtaining means that obtains a wheel acceleration of the driver's vehicle which is calculated based on a change of the wheel speed during a predetermined interval of time;
total acceleration obtaining means that obtains a total acceleration of the driver's vehicle which expresses a total acceleration including an acceleration of gravity given to the driver's vehicle detected by an acceleration sensor, the acceleration of gravity being given to the driver's vehicle;
drive state detection means that detects the driving state of the driver's vehicle, the drive state including at least a time at which the driver's vehicle enters a transition state based on at least the wheel speed obtained by the wheel speed obtaining means, where an acceleration actually given to the driver's vehicle along the longitudinal direction of the driver's vehicle is an actual acceleration in the longitudinal direction of the driver's vehicle, and the transition state is a state with a possibility that the wheel acceleration obtained by the wheel acceleration obtaining means is different from the actual acceleration in the longitudinal direction of the driver's vehicle by a predetermined value; and
acceleration calculation means that performs an acceleration calculation to calculate the acceleration in the longitudinal direction of the driver's vehicle during the transition state based on the wheel acceleration obtained by the wheel acceleration obtaining means and the total acceleration obtained by the total acceleration obtaining means,
the acceleration control means comprising:
gradient acceleration calculation means that calculates a gradient acceleration by subtracting the wheel acceleration obtained by the wheel acceleration obtaining means at the time when the driver's vehicle is shifted to the transition state from the total acceleration obtained by the total acceleration obtaining means at the time when the driver's vehicle is shifted to; and
gradient acceleration maintaining means that maintains the gradient acceleration calculated by the gradient acceleration calculation means,
wherein the acceleration control device outputs as the acceleration in the longitudinal direction of the driver's vehicle, a value obtained by subtracting the gradient acceleration maintained by the gradient acceleration maintaining means from the total acceleration, every obtained by the total acceleration obtaining means.

10. The acceleration control device according to claim 9, wherein the acceleration calculation means determines, as the period of the transition state, a period counted from a timing when the driver's vehicle enters the transition state to a timing when a predetermined time length is elapsed.

11. The acceleration control device according to claim 1, wherein the drive state detection means determines the timing to shift the driver's vehicle to the transition state when the wheel speed of more than a minimum detection speed of the wheel speed sensor becomes equal to the minimum detection speed, where the minimum detection speed is a wheel speed which is a minimum detectable speed by the wheel speed sensor based on a resolution thereof.

12. The acceleration control device according to claim 1, wherein the drive state detection means determines the timing to shift the driving state of the driver's vehicle to the transition state when a stop-state value of the driver's vehicle is changed to a start-state value of the driver's vehicle, where the stop-state value indicates the stop state of the driver's vehicle, and the start-state value expresses that the driver's vehicle starts.

13. The acceleration control device according to claim 9, wherein the drive state detection means determines the timing to shift the driving state of the driver's vehicle to the transition state when a predetermined interval of time is elapsed counted when the wheel speed of more than a minimum detection speed of the wheel speed sensor becomes equal to the minimum detection speed, where the minimum detection speed is a wheel speed which is a minimum detectable speed by the wheel speed sensor based on a resolution thereof.
